(19) United States
(12) Patent Application Publication
(10) Pub. No.: US 2026/0107155 A1
(43) Pub. Date: Apr. 16, 2026

(54) ELECTRONIC DEVICE, METHOD FOR WIRELESS COMMUNICATION, AND COMPUTER-READABLE STORAGE MEDIUM

(71) Applicant: Sony Group Corporation, Tokyo (JP)

(72) Inventors: Yingshuang BAI, Beijing (CN); Chen SUN, Beijing (CN)

(73) Assignee: Sony Group Corporation, Tokyo (JP)

(21) Appl. No.: 19/145,971

(22) PCT Filed: Feb. 4, 2024
(86) PCT No.: PCT/CN2024/075731

§ 371 Date: Jul. 7, 2025

(30) Foreign Application Priority Data
Feb. 9, 2023 (CN) 202310099117.9

(51) Int. Cl. H04W 16/28; H04W 24/08; H04W 24/10

(52) U.S. Cl. CPC H04W 16/28; H04W 24/08; H04W 24/10

(57) ABSTRACT

Provided are an electronic device, a method for wireless communication and a computer-readable storage medium. The electronic device comprises a processing circuit configured for: determining, on the basis of channel characteristics, a monitoring mode of a beam prediction model for acquiring predicted beam information at a future moment on the basis of measured beam information, wherein the monitoring mode indicates the future moment corresponding to the predicted beam information as a monitoring object.

The present application claims priority to Chinese Patent Application No. 202310099117.9, titled “ELECTRONIC DEVICE, METHOD FOR WIRELESS COMMUNICATION, AND COMPUTER-READABLE STORAGE MEDIUM”, filed on Feb. 9, 2023 with the China National Intellectual Property Administration, which is incorporated herein by reference in its entirety.

### FIELD

The present application relates to the field of wireless communication technology, and in particular to an electronic device, a method for wireless communication, and a computer-readable storage medium that facilitate effective monitoring of the performance of a beam prediction model.

### BACKGROUND

With the development of artificial intelligence (AI)/machine learning (ML) technology, the application of an AI/ML model in the field of wireless communication has also attracted increasing attention.

At present, using a prediction result of a beam prediction model based on the AI/ML model for beam management is one of important research directions. A beam prediction model may be trained with historical data of beam measurement, and the trained beam prediction model may be used to obtain predicted beam information based on measured beam information. Thus, by performing beam management with predicted beam information, a conventional beam scanning process can be partially replaced so as to reduce overhead.

In the process of using the predicted beam information for beam management, a monitoring mechanism may be started when necessary to monitor the performance of the beam prediction model, and it is expected that the performance of the beam prediction model may be effectively monitored.

### SUMMARY

A brief overview of the present disclosure is provided below, in order to provide a basic understanding of certain aspects of the present disclosure. However, it should be understood that this overview is not an exhaustive summary of the present disclosure. It is not intended to identify critical or essential elements of the present disclosure, nor is it intended to define the scope of the present disclosure. Its sole purpose is to present some concepts of the present disclosure in a simplified form, as a preface to the more detailed description provided later.

An object of at least one aspect of the present disclosure is to provide an electronic device, a method for wireless communication, and a computer-readable storage medium, that enable to determine, based on a channel characteristic, a monitoring mode of a beam prediction model, thereby facilitating effective monitoring of the performance of the beam prediction model.

According to an aspect of the present disclosure, an electronic device is provided. The electronic device includes processing circuitry, configured to: determine, based on a channel characteristic, a monitoring mode for a beam prediction model that obtains predicted beam information of a future time point based on measured beam information, the monitoring mode indicating a future time point corresponding to predicted beam information that is taken as a monitoring object.

According to another aspect of the present disclosure, a method for wireless communication is further provided. The method includes determining, based on a channel characteristic, a monitoring mode for a beam prediction model that obtains predicted beam information of a future time point based on measured beam information, the monitoring mode indicating a future time point corresponding to predicted beam information that is taken as a monitoring object.

According to another aspect of the present disclosure, a non-transitory computer-readable storage medium is further provided. The non-transitory computer-readable storage medium has an executable instruction stored thereon. The executable instruction, when executed by a processor, causes the processor to perform the above-described method for wireless communication or various functions of the above-described electronic device.

According to other aspects of the present disclosure, a computer program code and a computer program product for implementing the above-described method according to the present disclosure are also provided.

According to at least one aspect of the embodiments of the present disclosure, a monitoring mode of a beam prediction model is determined based on a current channel characteristic. The monitoring mode indicates a future time point corresponding to predicted beam information that is taken as a monitoring object. This makes it possible to effectively monitor the performance of the beam prediction model by using a monitoring mode that is suitable for a current channel characteristic.

Other aspects of the embodiments of the present disclosure are given in the following description section, in which the detailed description is used to fully disclose the preferred embodiments of the embodiments of the present disclosure without imposing limitations thereon.

### BRIEF DESCRIPTION OF THE DRAWINGS

The accompanying drawings described herein only illustrate selected embodiments rather than all possible implementations, and are not intended to limit the scope of the present disclosure. In the drawings:

FIG. 1 is a schematic diagram for illustrating beam management that uses a prediction result of a beam prediction model;

FIG. 2 is a block diagram illustrating an example configuration of an electronic device according to an embodiment of the present disclosure;

FIGS. 3A and 3B are tables for illustrating examples of a monitoring mode and an section for a channel fading rate;

FIGS. 4A and 4B are schematic diagrams for illustrating example processing for determining a monitoring start point;

FIGS. 5A to 5C are schematic diagrams for illustrating example processing for determining a monitoring object based on the monitoring mode and the monitoring start point;

FIG. 6 is a block diagram illustrating an example configuration of an electronic device implemented on a terminal side according to an embodiment of the present disclosure;

FIG. 7 is a flow chart for illustrating an example of a signaling interaction in which the electronic device implemented on the terminal side reports capability information to a network side;

FIG. 8 is a flow chart for illustrating an example of a signaling interaction in which the electronic device implemented on the terminal side performs beam prediction;

FIG. 9 is a flow chart for illustrating one example of a signaling interaction in which the electronic device implemented on the terminal side determines a monitoring mode;

FIG. 10 is a flow chart for illustrating one example of a signaling interaction in which the electronic device implemented on the terminal side measures a downlink monitoring beam;

FIG. 11 is a schematic diagram for illustrating an example of a MAC CE message for activating the downlink monitoring beam;

FIG. 12 is a flow chart for illustrating another example of a signaling interaction in which the electronic device implemented on the terminal side measures a downlink monitoring beam;

FIG. 13 is a block diagram illustrating an example configuration of an electronic device implemented on a network side according to an embodiment of the present disclosure;

FIG. 14 is a flow chart for illustrating one example of a signaling interaction in which the electronic device implemented on the network side obtains predicted beam information;

FIG. 15 is a flow chart for illustrating one example of a signaling interaction in which the electronic device implemented on the network side determines a monitoring mode;

FIG. 16 is a flow chart for illustrating one example of a signaling interaction in which the electronic device implemented on the network side transmits a downlink monitoring beam;

FIG. 17 is a flow chart for illustrating another example of a signaling interaction in which the electronic device implemented on the network side transmits a downlink monitoring beam;

FIG. 18 is a flow chart illustrating an example process of a method for wireless communication according to an embodiment of the present disclosure;

FIG. 19 is a block diagram illustrating a first example of a schematic configuration of an eNB to which the technology of the present disclosure may be applied;

FIG. 20 is a block diagram illustrating a second example of a schematic configuration of an eNB to which the technology of the present disclosure may be applied;

FIG. 21 is a block diagram illustrating an example of a schematic configuration of a smart phone to which the technology according to the present disclosure may be applied; and

FIG. 22 is a block diagram illustrating an example of a schematic configuration of a vehicle navigation device to which the technology according to the present disclosure may be applied.

Although the present disclosure may be susceptible to various modifications and alternative forms, specific embodiments thereof have been illustrated by way of examples in the drawings and have been described in detail herein. However, it should be understood that the description of specific embodiments herein is not intended to limit the present disclosure to the particular forms disclosed, but rather to cover all modifications, equivalents, and alternatives falling within the spirit and scope of the present disclosure. It should be noted that same or similar reference numerals are used throughout the drawings to refer to the same or like parts.

### DETAILED DESCRIPTION OF EMBODIMENTS

The embodiments of the present disclosure will be described completely in conjunction with the drawings. The following description is only exemplary, and is not intended to limit the present disclosure, and applications or usages thereof.

Exemplary embodiments are provided so that the present disclosure will be thorough and complete, and will fully convey the scope of the present disclosure to those skilled in the art. Numerous specific details, such as examples of specific components, devices, and methods, are described to provide a detailed understanding of the embodiments of the present disclosure. It is apparent for those skilled in the art that the exemplary embodiments may be implemented in many different forms without specific details, and should not be construed to limit the scope of the present disclosure. In some exemplary embodiments, well-known processes, well-known structures, and well-known technologies are not described in detail.

The descriptions are provided in the following order:
1. Overview
2. Configuration examples of an electronic device
   2.1 Configuration examples
   2.2 Configuration examples of an electronic device implemented on a terminal side
   2.3 Configuration examples of an electronic device implemented on a base station side
3. Method embodiments
4. Application examples

### 1. Overview

Before discussing the monitoring of a beam prediction model, a brief introduction is first given to the beam prediction model and its application in beam management.

As previously described, the beam prediction model based on the AI/ML model may be trained with historical data of beam measurement, and the trained beam prediction model is used to predict beam information. The AI/ML model employed by the beam prediction model may include various categories, for example but not limited to a model based on a neural network (such as a Convolutional Neural Network (CNN), a Recurrent Neural Network (RNN) such as a Long Short-Term Memory (LSTM) network, and the like) or a model of other AI/ML techniques, and the present disclosure places no limitation thereon.

As an example, beam management sub-use case 2 (BM-Case2) for downlink beam prediction, which is discussed in 3GPP meetings for beam management based on the AI/ML model, may be considered. In downlink beam prediction such as BM-Case2, the trained beam prediction model based on the AI/ML model may take, as input, measured beam information obtained by most recent K beam measurements or at K past time points, and output, for example, F pieces of predicted beam information for F future time points, where K and F are each a natural number greater than or equal to 1.

Here, for a given beam prediction model, K and F may be predefined model parameters, but the specific values of the F future time points or the specific interval between these time points may be related to the beam dwell time or the validity time of predicted beam information of each future time point, that is, the interval between two adjacent future time points corresponds to the beam dwell time or the validity time of predicted beam information of the earlier future time point. Accordingly, depending on the beam prediction model, the time point values or interval values of the F future time points may be predefined (for example, specifying the interval between each future time point and a current time at which the prediction is performed), or may be obtained as a part of model output (for example, outputting the interval between each future time point and the current time at which the prediction is performed and/or the interval between each future time point), and the present disclosure places no limitation thereon.

In the above beam prediction model, measured beam information of every beam measurement or at each past time point that is taken as input may include, but is not limited to, measurement information for L candidate beams, such as reference signal received power (RSRP) of the L candidate beams (L is a natural number greater than or equal to 1). Optionally, in a case in which the beam prediction model is an RNN-based model (such as an LSTM-based model), measured beam information obtained by every beam measurement or at each past time point may further include information of corresponding measurement time.

Predicted beam information of each future time point that is output by the beam prediction model may have various appropriate forms, for example may include, but is not limited to, predicted information of N predicted beams of a future time point, where the N predicted beams may be, for example, the first N candidate beams among the L candidate beams (N is a natural number greater than or equal to 1 and less than or equal to L). The predicted information of the N predicted beams may include, for example, identification information of each predicted beam (such as a beam ID) and one or more of the following information of each predicted beam: beam quality expressed, for example, by RSRP (such as L1-RSRP); probability of being an optimal beam (and optionally related confidence); beam application time or dwell time; and/or other related information that is capable of determining a priority of the predicted beam.

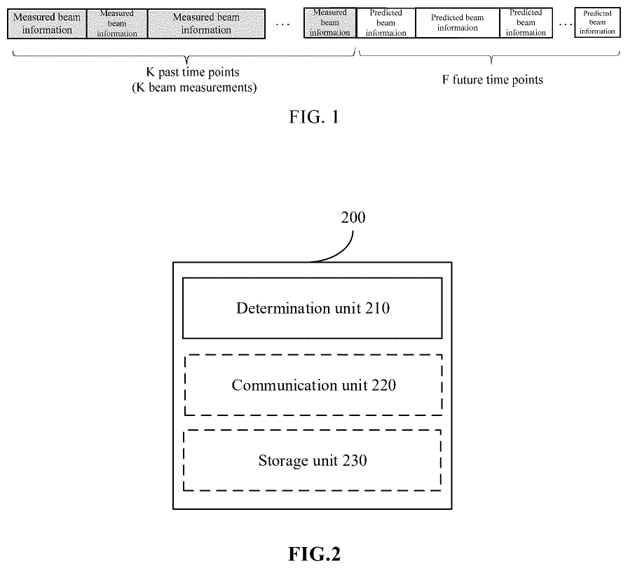

In beam management, the predicted beam information obtained by the beam prediction model described above may be used to partially replace measured beam information obtained by an existing beam sweeping or beam measurement process, thereby reducing overhead. FIG. 1 illustrates an example of beam management that uses a prediction result of a beam prediction model, in which measured beam information of K past time points (K beam measurements) and predicted beam information of F future time points that is obtained based on the measured beam information are used.

In the example of FIG. 1, for example, a beam measurement may be performed each time a beam failure occurs (or a beam measurement may be started again after predicted beam information of the F time points that is obtained by the previous prediction becomes invalid) so as to obtain measured beam information of K measurements or at K past time points. In addition, for example, a model prediction may be performed each time a next beam failure occurs after measured beam information of K measurements or at K past time points is obtained, so as to obtain predicted beam information of F future time points. The present disclosure imposes no particular limitation on conditions or timings for triggering the beam measurement and the beam prediction, and description thereof is omitted here.

In a beam management example such as that illustrated in FIG. 1, a beam failure may occur during beam management based on predicted beam information. The cause may be that the performance of the beam prediction model, for example the prediction accuracy, cannot meet the requirements, or may be that the transmission quality of a current link degrades or a channel mutation occurs at a certain time point. The latter case does not mean that the overall performance of the model decreases and in fact it is unnecessary to switch back to a traditional beam measurement. Therefore, it is expected that, a monitoring mechanism may be started to monitor the performance of the beam prediction model at an appropriate time (for example but not limited to when a beam failure occurs during beam management based on predicted beam information), so as to determine whether the whole model (rather than predicted beam information of a single time point) meets a predetermined requirement, thereby helping to determine whether it is necessary to switch back to a traditional beam measurement.

At present, how to appropriately select predicted beam information of a beam prediction model as a monitoring object for different situations has not yet been proposed.

In view of the above, the inventor proposes an inventive concept of the present invention as follows. A monitoring mode for a beam prediction model is determinized based on a channel characteristic. The monitoring mode indicates a future time point corresponding to predicted beam information that is taken as a monitoring object. This makes it possible to effectively monitor the performance of the beam prediction model by using a monitoring mode suitable for a current channel characteristic. Next, an apparatus or method embodiment based on the above inventive concept and various preferred examples and processing will be described in conjunction with the example of beam management in FIG. 1. It should be noted that, although a downlink beam management is taken as an example to describe an application background of the present disclosure below, those skilled in the art may understand, based on the present disclosure, that the present disclosure is not limited to the downlink beam management and may be appropriately applied to a uplink beam management, which will not be described in detail here.

### 2. Configuration Examples of an Electronic Device

### 2.1 Configuration Examples

FIG. 2 is a block diagram illustrating an example configuration of an electronic device according to an embodiment of the present disclosure.

As illustrated in FIG. 2, an electronic device 200 may include a determination unit 210. Optionally, the electronic device 200 may further include, for example, a communication unit 220 for transmitting information to or receiving information from another device, and a storage unit 230 for storing various data, programs, and information, etc.

Here, each unit of the electronic device 200 may be included in a processing circuit. It should be noted that the electronic device 200 may include one processing circuit or multiple processing circuit. Further, the processing circuitry may include various discrete functional units to perform various functions and/or operations. It should be noted that these functional units may be physical entities or logical entities, and units with different titles may be implemented by the same physical entity.

It should be noted that the electronic device 200 may be a network side device or may be a terminal device, and no limitation is made here. In addition, the electronic device 200 may have a deployed beam prediction model, that is, a beam prediction model is stored in its storage unit 230, so that the model may be used to directly obtain predicted beam information based on measured beam information. The electronic device 200 may also not have a beam prediction model, and may obtain information about the beam prediction model and/or various information necessary for monitoring the performance of the model, such as predicted beam information, via the communication unit 230, and no limitation is made here as well.

According to an embodiment of the present disclosure, the determination unit 210 of the electronic device 200 may be configured to determine, based on a channel characteristic, a monitoring mode for a beam prediction model that obtains predicted beam information of a future time point based on measured beam information, the monitoring mode indicating a future time point (which may also be referred to as a monitoring time point where appropriate herein) corresponding to predicted beam information that is taken as a monitoring object.

As an example, the channel characteristic described above may include a channel fading rate. The channel fading rate may be based on the mobility of a terminal device, and the determination unit 210 may determine or obtain an index of the channel fading rate in various appropriate ways.

In an example, the determination unit 210 may be configured to determine a current channel fading rate based on a predetermined reference signal received via the communication unit 220, for example. In a case in which the electronic device 200 is a network side device, the predetermined reference signal may be an uplink reference signal received from a terminal device. In a case in which the electronic device 200 is a terminal device, the predetermined reference signal may be a downlink reference signal received from a network side device. The determination unit 210 may perform channel estimation based on the received reference signal in various existing ways and determine a Doppler shift, and characterize the channel fading rate in an appropriate form of the Doppler shift (for example but not limited to a reciprocal of the Doppler shift), in which a larger Doppler shift indicates a faster channel fading rate. Alternatively, for example, in a case in which the electronic device 200 is a terminal device (or in a case in which the electronic device 200 is a network side device that may directly obtain a moving speed of a terminal device), the determination unit 210 may further characterize the channel fading rate directly by the moving speed of the terminal device, in which a higher moving speed of the terminal device indicates a faster channel fading rate, and description thereof is omitted here.

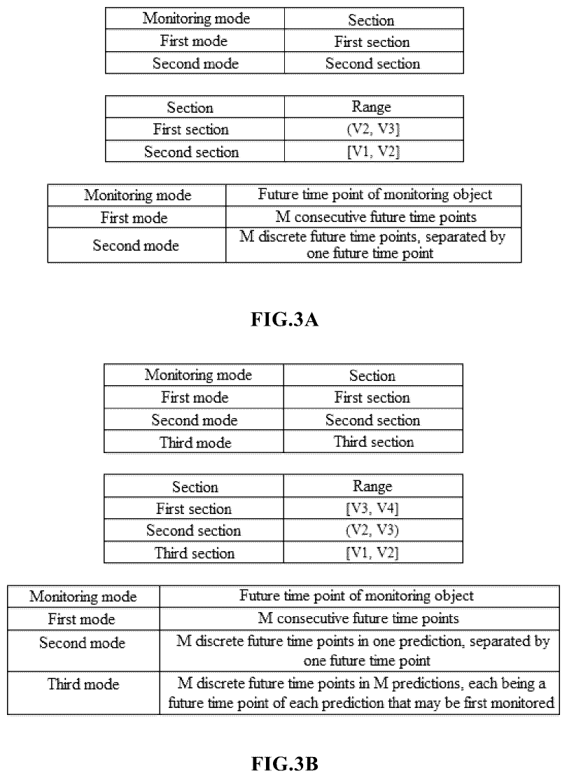

Preferably, the determination unit 210 may set, in advance and in an associated way, a plurality of predetermined sections for the channel fading rate and a plurality of monitoring modes, and store them in the storage unit 230. The upper tables in FIGS. 3A and 3B illustrate association examples of the above rate sections and the monitoring modes, the middle tables illustrate definition examples of each rate section, and the lower tables illustrate definition examples of each monitoring mode (described in detail later).

In such a case, the determination unit 210 may be configured to determine, based on a section among a plurality of predetermined sections into which a current channel fading rate falls, a mode that corresponds to that section among a plurality of monitoring modes. For example, when the example of predetermined sections and monitoring modes in FIG. 3A is applied, if the current channel fading rate falls into a first section between V2 and V3, the determination unit 310 determines a first mode that corresponds to the first section among a first mode and a second mode.

Preferably, among the plurality of predetermined sections set in advance by the determination unit 210, a channel fading rate of the first section is higher than that of the second section. Among the plurality of monitoring modes, a correlation between a plurality of future time points of a plurality of pieces of predicted beam information indicated by the first mode corresponding to the first section may be higher than a correlation between a plurality of future time points of a plurality of pieces of predicted beam information indicated by the second mode corresponding to the second section. The reason for the preferred setting described above is that a main influencing factor of the performance of a time-domain beam prediction model is the time variation of a channel. When the time variation of the channel is relatively gentle, only predicted beam information of time points having a relatively high correlation have prediction accuracy close to each other. Therefore, time points having the relatively high correlation may be selected so as to make, for example, monitoring objects relatively concentrated in time, thereby ensuring timeliness of performed model monitoring. In contrast, when the time variation of the channel is relatively gentle, even if the correlation between each time points is relatively low, the prediction accuracy of predicted beam information of these time points is also relatively stable (close to each other). Therefore, time points having the relatively low correlation may be selected so as to make, for example, monitoring objects relatively dispersed in time, thereby helping to avoid interference with the model monitoring caused by a channel mutation and the like. Accordingly, the preferred setting described above helps to appropriately select different monitoring modes for different channel scenarios, thereby facilitating effective monitoring of the performance of the beam prediction model.

As an example, the monitoring modes set in advance by the determination unit 210 may include: a first type of monitoring mode (a consecutive mode) that indicates consecutive future time points, and a second type of monitoring mode (a discrete mode) that indicates discrete future time points.

Preferably, the above two type of monitoring modes may both indicate future time points corresponding to predicted beam information that are obtained by the beam prediction model based on measured beam information of the same past time points, in other words, indicate consecutive or discrete future time points among F future time points that are obtained by one prediction (one model output) based on measured beam information of the same K measurements or at the same K past time points.

The lower table in FIG. 3A illustrates an example of two type of (two) monitoring modes in this case. In the present example, for the purpose of facilitating unified or simplified operation, each mode not only specifies whether the future time points (monitoring time points) of the monitoring objects are continuous or discrete, and additionally specifies the number M of the monitoring time points (M is a natural number less than F). In addition, the second mode, which is the discrete mode, additionally specifies an interval of the monitoring time points. It should be understood that the additional limitations described above are not necessary for the definition of the monitoring mode and can be omitted.

As illustrated in the upper and middle tables of FIG. 3A, the first mode and the second mode described above may respectively be applicable to a first section in which the channel fading rate is relatively fast and a second section in which the channel fading rate is normal or relatively slow. A specific range of each section (specific values of V1 to V3 in the middle table of FIG. 3A) may be set in various appropriate ways. In an example, the first section may correspond to a case in which a terminal device moves at a high speed (for example, is on a high-speed train), and the second section may correspond to a case in which a terminal device moves at a medium speed (for example, is carried by a user who is riding a bicycle or in a car) or at a low speed (for example, is carried by a walking user) or is stationary. Additionally or alternatively, the specific range of each section may be appropriately determined experimentally and the like such that the monitoring accuracy of the monitoring mode corresponding to each section meets a predetermined requirement, and description thereof is omitted here.

Alternatively, the first type of monitoring mode (the consecutive mode) described above may indicate consecutive future time points corresponding to predicted beam information obtained by one prediction, and the second type of monitoring mode (the discrete mode) may include two modes that respectively indicate discrete future time points corresponding to predicted beam information obtained by one prediction or by a plurality of predictions. In other words, a first discrete mode may indicate future time points corresponding to predicted beam information that are obtained by the beam prediction model based on measured beam information of the same past time points (one prediction based on measured beam information of the same K measurements or at the same K past time points), and a second discrete mode may indicate future time points corresponding to predicted beam information that are obtained by the beam prediction model based on measured beam information of different past time points (a plurality of predictions respectively based on a plurality of sets of measured beam information of the K measurements or at the K past time points).

The lower table in FIG. 3B illustrates an example of two type of (three) monitoring modes in this case. The definitions of a first mode (a consecutive mode) and a second mode (a first discrete mode) in FIG. 3B actually correspond respectively to the definitions of the first mode and the second mode in FIG. 3A, and repeated description is omitted here. For the purpose of facilitating unified or simplified operation, a third mode as a second discrete mode in FIG. 3B additionally specifies a position of a monitoring time point in the plurality of predictions. It should be understood that the additional limitations described above are not necessary for the definition of the monitoring mode and can be omitted.

As illustrated in the upper and middle tables of FIG. 3B, the first mode, the second mode and the third mode described above may respectively be applicable to a first section in which the channel fading rate is relatively fast, a second section in which the channel fading rate is normal and a third section in which the channel fading rate is relatively slow. A specific range of each section (specific values of V1 to V4 in the middle table of FIG. 3B) may be set in various appropriate ways. In an example, the first section may correspond to a case in which a terminal device moves at a high speed (for example, is on a high-speed train), the second section may correspond to a case in which a terminal device moves at a medium speed (for example, is carried by a user who is riding a bicycle or in a car), and the third section may correspond to a case in which a terminal device moves at a low speed (for example, is carried by a walking user) or is stationary. Additionally or alternatively, the specific range of each section may be appropriately determined experimentally and the like such that the monitoring accuracy of the monitoring mode corresponding to each section meets a predetermined requirement, and description thereof is omitted here.

Although not explicitly illustrated in partial examples of the monitoring modes in FIGS. 3A and 3B, preferably, a start point of M future time points specified by each mode (that is, the first one of the M time points, which may also be referred to as a monitoring start point time point) may be a time point at which predicted beam information may be first monitored from a monitoring trigger time point. For example, predicted beam information corresponding to that time point is taken as a monitoring start point.

Optionally, the determination unit 210 may further be configured to determine predicted beam information that is taken as a monitoring start point.

The determination unit 210 may determine the monitoring start point in various ways. In one example, the determination unit 210 may be configured to determine, as the predicted beam information that is taken as the monitoring start point, predicted beam information corresponding to a time point at which a predetermined time elapses since a monitoring trigger time point of the beam prediction model. Preferably, the predetermined time herein is determined based on the time required to measure all predicted beams (for example N predicted beams) indicated by predicted beam information of a future time point (for example scanning time of the N predicted beams), and may be equal to or slightly greater than the scanning time of the N predicted beams, for example. The configuration of the determination unit 210 described above helps to accurately determine a time point at which predicted beam information may be first monitored (that is, the earliest time point at which it is capable of being ensured that measurement of N predicted beams indicated by a piece of predicted beam information is complete).

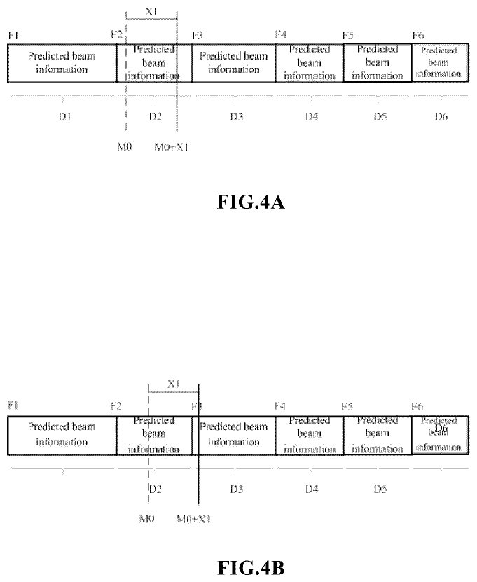

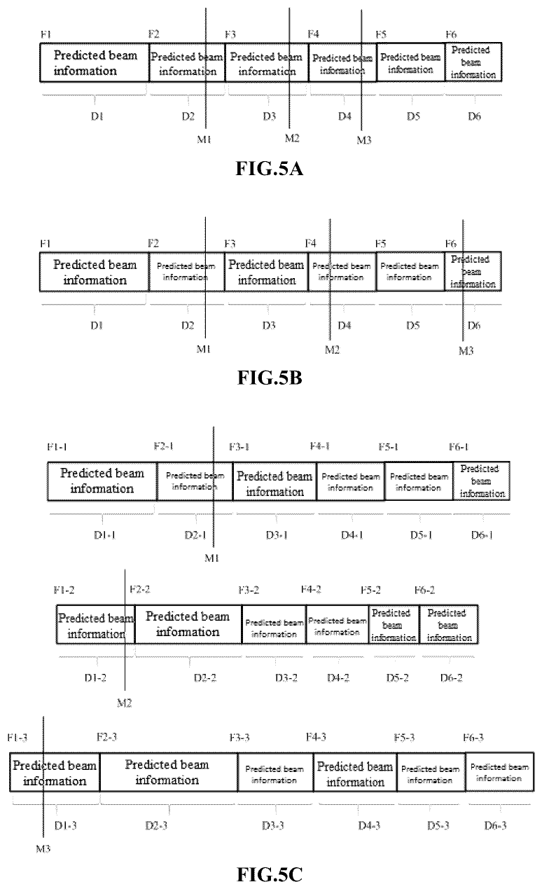

FIGS. 4A and 4B illustrate examples of determining a monitoring start point in the above way. In this example, the beam prediction model outputs predicted beam information of F=6 future time points F1 to F6, whose validity times or dwell times are D1 to D6 respectively, based on measured beam information of K measurements or at K past time points in one prediction. During the beam dwell time D2 of predicted beam information of time point F2, a beam failure occurs at time point M0, thereby triggering the start of the monitoring mechanism.

In this example, the determination unit 210 may determine the time point (M0+X1), which is the time point at which a scanning time X1 of the N predicted beams elapses since the monitoring trigger time point M0, falls into the validity time or dwell time of predicted beam information corresponding to which time point, and correspondingly determine predicted beam information corresponding to that time point as a monitoring start point. That is, in the example of FIG. 4A, M0+X1 falls into the validity time D2 of time point F2, which means that the measurement of N predicted beams indicated by predicted beam information of time point F2 can be completed within the validity time D2 from M0. Therefore, the determination unit 210 may determine predicted beam information of time point F2 as the monitoring start point. Alternatively, in the example of FIG. 4B, M0+X1 falls into the validity time D3 of time point F3, which means that measurement of N predicted beams indicated by predicted beam information of time point F2 cannot be completed within the validity time D2 from M0. Therefore, the determination unit 210 determines predicted beam information of time point F3 of the earliest as the monitoring start point.

It should be noted that although the above describes examples of determining the monitoring start point based on where M0+X1 falls, the present disclosure is not limited thereto. In an alternative example, the determination unit 210 may directly use predicted beam information of a time point (for example time point F2), which corresponds to the monitoring trigger time point M0, as the start point so as to ensure the execution speed of monitoring. In such a case, if measurement of all predicted beams of that time point cannot be completed within the corresponding time (for example the validity time D2 of time point F2), a measurement result of a predicted beam for which a result is not obtained may be replaced with a predetermined value. In another alternative example, predicted beam information of the next future time point (for example time point F3) of the time point corresponding to the monitoring trigger time point M0 may also be directly used as the start point so as to ensure the accuracy of monitoring.

Next, an example process in which the determination unit 210 determines a monitoring object based on the determined monitoring mode and the monitoring start point will be described with reference to FIGS. 5A to 5C. FIGS. 5A to 5C are schematic diagrams for illustrating an example process of determining a monitoring object based on the monitoring mode and the monitoring start point, which respectively illustrate examples of monitoring objects determined based on the first, the second or the third mode illustrated in FIG. 3B and the monitoring start point (predicted beam information of time point F2) illustrated in FIG. 4A. In the examples of FIGS. 5A to 5C, the output of the beam prediction model is similar to that in the examples of FIGS. 4A and 4B, the difference is that in the example of FIG. 5C, suffixes -1, -2 or -3 are added after the reference signs related to the future time points and the validity times or dwell times so as to distinguish them since three predictions (three model outputs) are involved.

In the examples of FIGS. 5A to 5C, the start of the monitoring mechanism is triggered by a beam failure within the dwell time D2 of predicted beam information of time point F2, and the determination unit 210 determines the monitoring start point as F2 for example by the example process described above with reference to FIG. 4A, and determines different modes based on a current channel fading rate falling within the first, the second or the third section respectively, and accordingly specifies M=3 consecutive or discrete monitoring objects starting from the monitoring start point F2, and schematically illustrates the time points M1, M2 or M3 at which the measurement (the measurement of predicted beams indicated by the monitoring object) may be performed within a dwell time of each monitoring object, so as to mark each monitoring object. That is, in the example of the first mode in FIG. 5A, three consecutive future time points F2 to F4 starting from F2 are specified. In the example of the second mode in FIG. 5B, three discrete future time points F2, F4 and F6 that are spaced apart by one time point starting from F2 are specified. In the example of the third mode in FIG. 5C, future time point F2-1, F1-2 or F1-3 which may be first monitored of each of three predictions is specified.

In this way, the determination unit 210 may, for different channel characteristics such as a channel fading rate, correspondingly determine a monitoring mode for a beam prediction model and indicate a future time point corresponding to predicted beam information that is taken as a monitoring object, thereby enabling effective supervision of the performance of the beam prediction model by using a monitoring mode suitable for a current channel characteristic.

Optionally, the determination unit 210 may further be configured to determine the performance of the beam prediction model based on a measurement result of a predicted beam indicated by the predicted beam information that is taken as the monitoring object.

As an example, a measurement result of each predicted beam among N predicted beams indicated by predicted beam information of a time point may be beam quality expressed, for example, by RSRP. The determination unit 210 may compare measurement results of N predicted beams of a time point with the relevant information of the corresponding predicted beams indicated by predicted beam information of that time point so as to determine the prediction accuracy of the N predicted beams of that monitoring time point. The determination unit 210 may determine the prediction accuracy of the beam prediction model as an index of the model performance based on the prediction accuracy of each monitoring time point, that is, the prediction accuracy of each monitoring object.

In one example, the related information about each predicted beam in the predicted beam information may be the predicted beam quality expressed, for example, by RSRP. In this case, the determination unit 210 may directly calculate a difference between measurement results of N predicted beams of each monitoring time point and the predicted beam quality of corresponding predicted beams indicated by predicted beam information of that time point as an error, and determine the prediction accuracy of the prediction model based on the cumulative error or the average error of the respective monitoring time points.

In another example, the related information about each predicted beam in the predicted beam information may be a probability of being an optimal beam (and, optionally, related confidence) and/or other related information that is capable of determining a priority of the predicted beam. In this case, the determination unit 210 may directly determine the priority of the N predicted beams based on the measurement results of the N predicted beams of each monitoring time point (for example, higher measurement beam quality expressed, for example, by RSRP indicates higher priority), compare the above priority with the priority of the corresponding predicted beam indicated by the predicted beam information corresponding to that time point (for example, higher probability of being the optimal beam indicates higher priority), and determine the prediction accuracy of the prediction model based on the cumulative error or the average error of the priorities of the respective monitoring time points.

Optionally, the determination unit 210 may further be configured to determine that the prediction accuracy of the prediction model cannot meet a predetermined requirement when the cumulative error or the average error of the respective monitoring time points is greater than the corresponding threshold, thereby determining that it is necessary to switch back to a traditional beam measurement, which will not be described in detail here.

It should be noted that, in practical application, a case may occur in which the number of monitoring objects determined by the determination unit 210 based on the monitoring mode and the monitoring start point does not satisfy the number specified by the monitoring mode. For example, in the example of the first mode (the consecutive mode that specifies three consecutive time points) of FIG. 5A, if a beam failure occurs within the dwell time D5 of predicted beam information of time point F5, at most predicted beam information of time points F5 and F6 may be determined as two monitoring objects. At this time, the determination unit 210 may, for example, perform corresponding monitoring only on the two determined monitoring objects, which will not be described in detail here.

The basic configuration example of the electronic device 200 according to the embodiments of the present disclosure has been described above. Next, configuration examples and example processes of the electronic device 200 when implemented on a base station side and on a terminal side will be further described.

### 2.2 Configuration Examples of an Electronic Device Implemented on a Terminal Side

First, an example case in which an electronic device is implemented on a terminal side, for example but not limited to, being implemented as a terminal device, is considered.

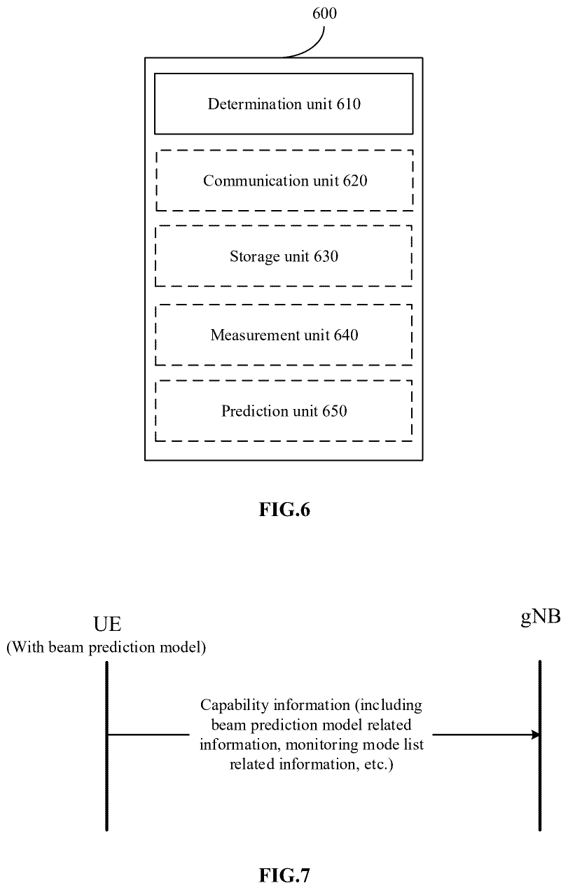

FIG. 6 is a block diagram illustrating a configuration example of an electronic device implemented on a terminal side. As illustrated in FIG. 6, an electronic device 600 of the present configuration example may include a determination unit 610, a communication unit 620 and a storage unit 630, which respectively correspond to the determination unit 210, the communication unit 220 and the storage unit 230 of the electronic device 200 illustrated in FIG. 2. A difference between the electronic device 600 and the electronic device 200 is that the determination unit 610, the communication unit 620 and the storage unit 630 may perform additional operations compared to the respective units of the electronic device 200, and the electronic device 600 further includes, optionally, a measurement unit 640 for beam measurement and a prediction unit 650 for beam prediction. The following description focuses on these different portions and related processing, including configuration, processing, and signaling interaction of the electronic device and its respective units.

### Reporting of Information Related to a Beam Prediction Model and the Like

In the case in which the electronic device is implemented on the terminal side, the electronic device 600 is preferably provided with a beam prediction model. That is, preferably, the electronic device 600 stores, in the storage unit 630, a trained beam prediction model and a list of monitoring modes and channel fading rate sections that are associated with each other, such as that illustrated in FIGS. 3A and/or 3B, in advance.

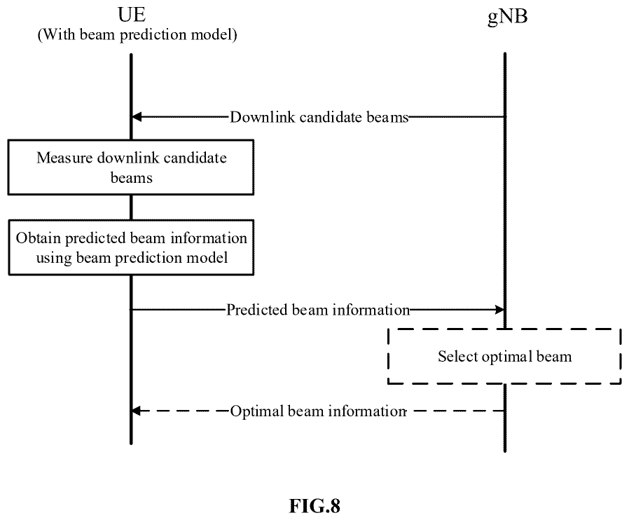

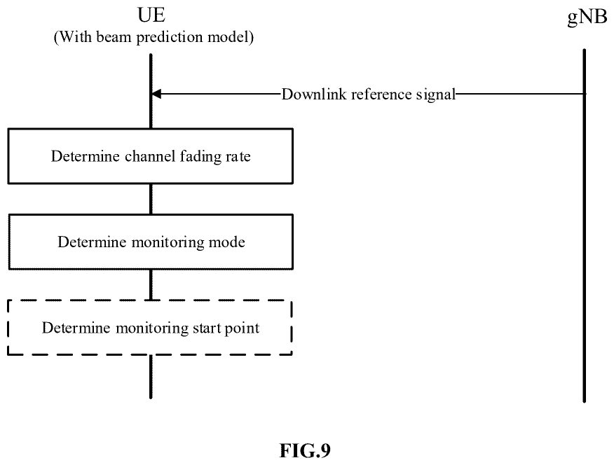

In this case, preferably, the electronic device 600 on the terminal side may report capability information of the terminal device to a network side device via its communication unit 620, including information related to the beam prediction model (which may indicate various information related to the beam prediction model such as model parameters K and F) and information related to the list of the monitoring modes (which may indicate various information related to, for example, the list of the monitoring modes having the form of the lower tables of FIGS. 3A and/or 3B) as part of the capability information. FIG. 7 illustrates a flow chart of an example of a signaling interaction in which the electronic device 600 reports capability information, where a terminal device UE has functions of the electronic device 600, and a base station gNB serves the UE.

### Beam Prediction/Obtaining of Predicted Beam Information and the Like

The electronic device 600 on the terminal side may perform beam prediction based on the beam prediction model via necessary interaction with the network side device so as to obtain predicted beam information. FIG. 8 illustrates a flow chart of an example of a signaling interaction in which the electronic device 600 performs beam prediction.

In the example of FIG. 8, a terminal device UE having the functions of the electronic device 600 may receive such as L downlink candidate beams transmitted by a base station gNB serving the UE via its communication unit 620, and measure the downlink candidate beams by its measurement unit 640. Thereafter, the UE may obtain, for example, predicted beam information of F future time points by using, via its prediction unit 650, the beam prediction model stored in the storage unit 630 based on measurement results (measured beam information) of the L downlink candidate beams of the most recent K measurements or at the most recent K past time points. It should be noted that, although only a single transmission and measurement of the downlink candidate beams is schematically illustrated in the figure, the process is repeated K times before the UE performs beam prediction by using the beam prediction model so that the UE obtains measured beam information of the most recent K measurements or at the most recent K past time points required by the model.

Here, predicted beam information of each future time point obtained by the UE by using the beam prediction model may, for example, include or indicate predicted information of the first N predicted beams among the L candidate beams. As an example, predicted information of the N predicted beams of a future time point may include, for example, identification information of each predicted beam (such as a beam ID) and beam quality expressed, for example, by RSRP (for example L1-RSRP) of each predicted beam (alternatively or additionally, a probability of being the optimal beam (and, optionally, related confidence) and/or other related information that is capable of determining a priority of the predicted beam), and may further include dwell times of the N predicted beams.

In addition, the UE may further transmit the obtained predicted beam information of the F future time points to the gNB as the network side device via its communication unit 620. The gNB may select, based on the received predicted beam information, one of the N predicted beams of each future time point as an optimal beam, for example but not limited to a predicted beam having the best beam quality (the maximum RSRP). Optionally, the gNB may transmit optimal beam information indicating the selected optimal beam to the UE.

### Monitoring of the Beam Prediction Model

### Determination of the Monitoring Mode

Within the dwell time of the optimal beam selected by the network side device based on the predicted beam information (for example within the dwell time D2 of time point F2 illustrated in FIG. 4A or FIG. 4B), a beam failure of a downlink beam may occur. At this time, monitoring of the beam prediction model will be triggered. In such a case, the electronic device 600 may determine a monitoring mode corresponding to a current channel characteristic such as a channel fading rate via appropriate interaction with the network side device, for example.

FIG. 9 illustrates a flow chart of an example of a signaling interaction in which the electronic device 600 determines a monitoring mode.

In the example of FIG. 9, a terminal device UE having the functions of the electronic device 600 may receive a predetermined downlink reference signal (for example but not limited to a Channel State Information-Reference Signal (CSI-RS)) transmitted by a base station gNB serving the UE via its communication unit 620, and determine a current channel fading rate based on the received downlink reference signal by the determination unit 610 in the way described earlier. Next, the UE may determine a monitoring mode corresponding to an section into which the current channel fading rate falls by its determination unit 610 referring to the list of the monitoring modes and the channel fading rate sections associated with each other (for example having the form illustrated in FIG. 3A or FIG. 3B) stored in the storage unit 630.

Optionally, the UE may further determine predicted beam information that is taken as a monitoring start point appropriately by its determination unit 610, for example in the way described above with reference to FIGS. 4A and 4B, which will not be described in detail here.

### Reporting of Monitoring Mode Information and the Like as Well as Reception and Measurement of Downlink Monitoring Beams

Optionally, in order for the network side device to transmit downlink monitoring beams for the predicted beam information that is taken as a monitoring object so as to perform measurement, the determination unit 610 of the electronic device 600 may further generate monitoring mode information and, optionally, monitoring start point information and the like, and report these information to the network side device via the communication unit 600.

Specifically, for example, after determining the monitoring mode, the determination unit 610 of the electronic device 600 may further generate monitoring mode information indicating the determined monitoring mode, which may indicate, for example, identification information of the determined monitoring mode. For example, in a case in which the example of the list of the monitoring modes in FIG. 3A is adopted, the generated monitoring mode information may have a single-bit form of 0 or 1 to respectively indicate the first mode or the second mode. In a case in which the example of the list of the monitoring modes in FIG. 3B is adopted, the generated monitoring mode information may have a bit-sequence form of 00, 01 or 10 to respectively indicate the first mode, the second mode or the third mode.

Optionally, the determination unit 610 may further generate monitoring start point information that indicates a monitoring start point, which may, for example, indicate, but is not limited to, identification information of the determined monitoring start point time point. For example, in a case in which a parameter F of a beam prediction model stored and applied by the electronic device 600 has a value of 6 (that is, the model outputs predicted beam information of 6 future time points), the generated monitoring start point information may have a 3-bit bit-sequence form so as to respectively indicate one of 6 time points F1 to F6.

The electronic device 600 may transmit monitoring mode information (and, optionally, monitoring start point information) such as in the above-mentioned form to the network side device via its communication unit 620, so that the network side device may determine and transmit corresponding downlink monitoring beams, that is, may determine and transmit predicted beams indicated by the predicted beam information that is taken as the monitoring object, based on the predicted beam information and the monitoring mode information (and, optionally, previously obtained information related to the beam prediction model and information related to the list of the monitoring modes, and optionally the monitoring start point information).

For example, in a case in which the monitoring mode information transmitted by the electronic device 600 to the network side device indicates identification information of a monitoring mode, the network side device may determine a monitoring mode indicated by the identification information based on previously obtained information related to the list of the monitoring modes (which may, for example, indicate a list having a form such as that illustrated in the lower part of FIG. 3A or FIG. 3B), and optionally determine a monitoring start point based on the monitoring start point information (in combination with previously obtained information related to the beam prediction model), thereby determining respective monitoring objects (that is, future time points corresponding to predicted beam information that are taken as the monitoring objects) starting from the monitoring start point, The specific process may be similar to the example process described earlier with reference to FIGS. 5A to 5C, and is not be repeated here. Next, the network side device may determine N predicted beams specified by each piece of predicted beam information that is taken as the monitoring object as downlink monitoring beams of respective time points, and transmit corresponding downlink monitoring beams during the beam dwell time of the predicted beam information.

Accordingly, a measurement unit 640 of the electronic device 600 may receive and measure the above downlink monitoring beams that are determined and transmitted by the network side device based on the predicted beam information and the monitoring mode information. Measurement results of these downlink monitoring beams are the measurement results of the “predicted beams indicated by predicted beam information that is taken as the monitoring object” described earlier in section “2.1 Configuration example” and may be used to determine the performance of the beam prediction model in the way described earlier. For example, a determination unit 610 of the electronic device 600 may determine the performance of the beam prediction model based on the above measurement results. Alternatively, the electronic device 600 may report the measurement results of the downlink monitoring beams to the network side device via the communication unit 620 for example, so that the network side device may determine the performance of the beam prediction model. The present embodiment places no limitation on an entity that finally determines the performance of the beam prediction model, and description is omitted here.

Preferably, in order for the electronic device 600 on the terminal side to measure the downlink monitoring beams, the network side device may also configure measurement resources of the downlink monitoring beams for the terminal device based on the predicted beam information and the monitoring mode information, and generate measurement configuration information accordingly. Here, the network side device may configure frequency resources of the downlink monitoring beams in various ways, but time resources configured for the downlink monitoring beams should be within the beam dwell time of the corresponding predicted beam information that is taken as the monitoring object. Accordingly, the communication unit 620 of the electronic device 600 may receive measurement configuration information of the downlink monitoring beams generated by the network side device based on the predicted beam information and the monitoring mode information, and its measurement unit 640 may measure the downlink monitoring beams with respect to resources indicated by the measurement configuration information.

Next, two examples in which the electronic device 600 receives and measures the downlink monitoring beams will be described in conjunction with different configurations of the measurement resources of the downlink monitoring beams.

First, a first example is discussed. In the first example, after determining downlink monitoring beams of a terminal device based on the received predicted beam information and the monitoring mode information, the network side device may configure, via RRC signaling, a non-periodic downlink reference-signal resource set for the electronic device 600 on the terminal side to carry these downlink monitoring beams, and may simultaneously trigger respective downlink reference signals in the resource set to be sequentially transmitted based on respective designated slot offsets via a DCI command.

For example, the network side device may configure a non-periodic non-zero-power CSI-RS (nzp-CSI-RS) resource set for the electronic device 600 on the terminal side. The resource set may include M subsets that respectively correspond to M monitoring objects, in which an m-th subset includes N nzp-CSI-RSs, a transmitting beam of each nzp-CSI-RS corresponds to one of N predicted beams indicated by predicted beam information that is taken as an m-th monitoring object, that is, one of N downlink monitoring beams that should be transmitted during the beam dwell time corresponding to the m-th monitoring object, where m=1, . . . , M. Alternatively or similarly, each subset may also include N Synchronization Signal Blocks (SSBs), which will not be described in detail here.

In such a case, the configuration information of the nzp-CSI-RS resource set (that is, the measurement configuration information of the downlink monitoring beams) generated and transmitted by the network side device to the electronic device 600 on the terminal side through RRC signaling may be in the form of a CSI-MeasConfig IE (or, alternatively, in the form of a CSI-ReportConfig IE), in which a measurement item is RSRP (L1-RSRP) and a measurement object (that is, the downlink resource) is the above nzp-CSI-RS resource set.

Preferably, in this configuration, for each subset in the nzp-CSI-RS resource set, the network side device may configure time resources of N nzp-CSI-RSs in the subset based on measurement time required by the electronic device 600 at the terminal side to measure a single beam, so that the N nzp-CSI-RSs in the current subset may be sequentially transmitted and an interval between transmitting times of two temporally adjacent nzp-CSI-RSs is equal to or slightly greater than the measurement time required to measure the single beam. The above configuration of the time resources may be achieved, for example but not limited to, by configuring a distance between slot offsets of respective nzp-CSI-RSs in each subset.

In addition, preferably, for an m-th subset of the non-periodic nzp-CSI-RS resource set, the network side device may configure time resources of N nzp-CSI-RSs in the subset based on a validity time or a beam dwell time corresponding to the m-th monitoring object, so that a transmitting time of each nzp-CSI-RS of the subset is within the above validity time or beam dwell time. As an example, the above configuration of time resources of a first subset may, for example but not limited to, be achieved by configuring a slot offset of a first nzp-CSI-RS to be transmitted to 1 (that is, the nzp-CSI-RS is transmitted immediately after being triggered by the DCI command), and the configuration of the above time resources of a subsequent m-th subset may be achieved by configuring an appropriate distance between a slot offset of a first nzp-CSI-RS to be transmitted and a slot offset of an N-th nzp-CSI-RS to be transmitted in an (m−1)-th subset, which will not be described in detail here.

The M*N nzp-CSI-RSs of the above non-periodic nzp-CSI-RS resource set may be simultaneously triggered by a DCI command that indicates a resource-set ID of the resource set transmitted by the network side device, and may be sequentially transmitted based on the configured slot offsets.

A non-periodic nzp-CSI-RS resource set configured and triggered in the above way may be applied, for example but not limited to, to a consecutive mode such as the first mode described earlier. For example, assuming that the network side device determines, for example, predicted beam information of time points F2 to F4 in the example of the first mode illustrated in FIG. 5A as monitoring objects based on the predicted beam information and the monitoring mode information, the network side device may configure a non-periodic nzp-CSI-RS resource set that includes three subsets respectively for the monitoring of predicted beam information of time points F2, F3 or F4. Each subset includes, for example, N=4 nzp-CSI-RSs that respectively correspond to one of four predicted beams indicated by the predicted beam information of time point F2, F3 or F4, and slot offsets of respective nzp-CSI-RSs satisfy the requirements described above.

The electronic device 600 on the terminal side may receive, via the communication unit 620, the configuration information and the DCI triggering command transmitted by the network side device immediately after the configuration of the above nzp-CSI-RS resource set is completed. The electronic device 600 on the terminal side may receive and measure downlink monitoring beams carried by the nzp-CSI-RS resource set based on indications of the configuration information of the nzp-CSI-RS resource set and the DCI triggering command by the communication unit 620 and the measurement unit 640 respectively.

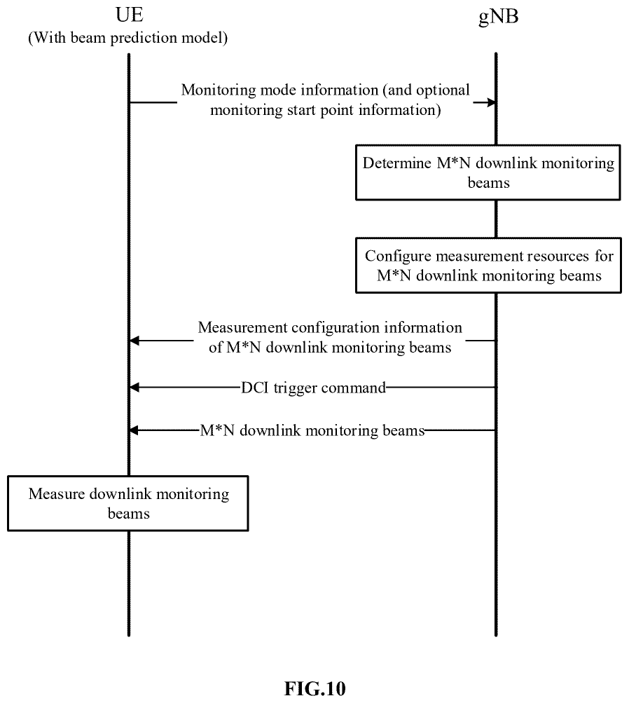

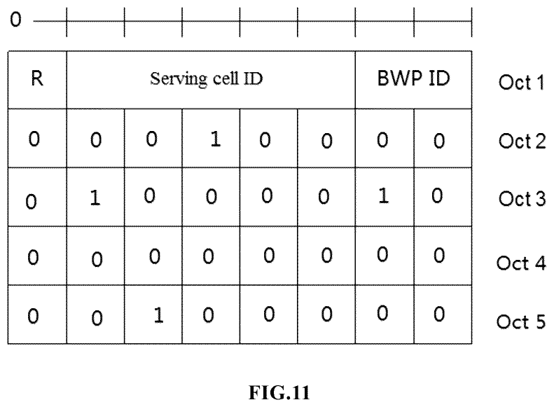

FIG. 10 illustrates a signaling-interaction flow of a first example in which the electronic device 600 receives and measures a downlink monitoring beam.

As illustrated in FIG. 10, a UE having the functions of the electronic device 600 transmits monitoring mode information (and, optionally, monitoring start point information) to a base station gNB serving the UE as the network side device so that the gNB may accordingly determine, in combination with previously received predicted beam information, for example M*N downlink monitoring beams for monitoring objects. The gNB may configure a non-periodic nzp-CSI-RS resource set, such as that described above, as measurement resources for these downlink monitoring beams, accordingly generate the configuration information thereof as measurement configuration information of the M*N downlink monitoring beams, and transmit the configuration information to the UE. The gNB may also transmit a DCI triggering command for triggering the above resource set to the UE and subsequently transmit the M*N downlink monitoring beams carried by the non-periodic nzp-CSI-RS resource set. After receiving the above measurement configuration information and the corresponding DCI triggering command from the gNB, the UE may receive and measure the M*N downlink monitoring beams carried by the non-periodic nzp-CSI-RS resource set based on indications of the measurement configuration information and the DCI triggering command.

Next, a second example in which the electronic device 600 receives and measures the downlink monitoring beams is discussed. In the second example, after determining downlink monitoring beams of a terminal device based on the received predicted beam information and the monitoring mode information, the network side device may configure, via RRC signaling, a plurality of non-periodic downlink reference-signal resources for the electronic device 600 on the terminal side to carry these downlink monitoring beams, and may activate, for each monitoring object, corresponding downlink reference signals to be sequentially transmitted, for example, based on respective designated slot offsets via corresponding MAC CE command.

Specifically, for example, the network side device may configure M*N non-periodic nzp-CSI-RS resources for M monitoring objects that respectively indicate N predicted beams, that is, for a total of M*N predicted beams, in which each nzp-CSI-RS resource may correspond to one of the M*N predicted beams, that is, one of the N downlink monitoring beams that should be transmitted during the beam dwell time corresponding to an m-th monitoring object, where m=1, . . . , M, and each nzp-CSI-RS resource may, for example, be represented by a corresponding index among indexes from 1 to M*N. Alternatively or similarly, the network side device may also configure M*N SSBs, which will not be described here.

In such a case, the configuration information of the nzp-CSI-RS resources (that is, the measurement configuration information of the downlink monitoring beams) generated and transmitted by the network side device to the electronic device 600 on the terminal side through RRC signaling may be in the form of a CSI-MeasConfig IE (or, alternatively, in the form of a CSI-ReportConfig IE), in which a measurement item is RSRP (L1-RSRP) and a measurement object (that is, the downlink resource) is the above M*N nzp-CSI-RSs.

Preferably, in this configuration, the network side device may configure time resources of N nzp-CSI-RSs for each monitoring object so that the N nzp-CSI-RSs may be sequentially transmitted and an interval between transmitting times of two temporally adjacent nzp-CSI-RSs is equal to or slightly greater than the measurement time required to measure a single beam. The above configuration of the time resources may be achieved, for example but not limited to, by configuring a distance between slot offsets of N nzp-CSI-RSs of each monitoring object.

The above M*N non-periodic nzp-CSI-RSs may be correspondingly activated by M MAC CEs transmitted by the network side device for the M monitoring objects and respectively indicating N nzp-CSI-RSs of a current monitoring object (that is, N nzp-CSI-RSs of a current monitoring object are activated each time), and may be transmitted sequentially based on the configured time slot offset after activation. Here, preferably, the network side device may transmit a corresponding MAC CE activation message as early as possible within the beam dwell time corresponding to each monitoring object so as to ensure that the measurement of corresponding N downlink monitoring beams is completed as early as possible within the time.

FIG. 11 illustrates an example of a MAC CE activation message that may be used in the present example. In this example, there are M=8 monitoring objects, and each monitoring object (predicted beam information) indicates N=4 predicted beams. Accordingly, the network side device configures M*N=32 non-periodic nzp-CSI-RSs. As illustrated in FIG. 11, in such a case, a MAC CE activation message received by the electronic device 600 on the terminal side from the network side device via the communication unit 620 may include four 8-bit bitmaps. That is, in Oct2 to Oct5, 1-bit information used to indicate whether an i-th nzp-CSI-RS among the configured 32 nzp-CSI-RSs is selected is included. A value 1 indicates that the i-th nzp-CSI-RS is selected and a value 0 indicates that the i-th nzp-CSI-RS is not selected (i=1, 2, . . . , 32). More specifically, the MAC CE message illustrated in FIG. 11 specifies that the 4-th, 10-th, 15-th and 27-th nzp-CSI-RSs (for example nzp-CSI-RSs having corresponding indexes) are selected as resources of the four downlink monitoring beams for the current monitoring object via four bit values of 1 in Oct2, Oct3 and Oct5. It should be understood that the MAC CE activation message of FIG. 11 is merely an example, and the number of 8-bit bitmaps included in the MAC CE may be suitably selected based on a value of M*N so as to ensure that the selection of the M*N downlink monitoring beams may be indicated, which will not be described here.

Non-periodic nzp-CSI-RS resources configured and activated as described above may be applied, for example but not limited to, to a discrete mode such as the second or the third mode described earlier. For example, assuming that the network side device determines predicted beam information of time points F2, F4 and F6 in the example of the second mode illustrated in FIG. 5B as monitoring objects based on the predicted beam information and the monitoring mode information, the network side device may configure M*N=3×4=12 non-periodic nzp-CSI-RSs that respectively correspond to one of four predicted beams indicated by predicted beam information of time point F2, F4 or F6, and slot offsets of the respective nzp-CSI-RSs satisfy the requirements described above.

The electronic device 600 on the terminal side may receive, via the communication unit 620, the configuration information transmitted by the network side device immediately after the configuration of the above M*N=12 nzp-CSI-RSs is completed. Next, the electronic device 600 may receive, via the communication unit 620, a MAC CE activation message transmitted by the network side device as early as possible within the beam dwell time D2 of predicted beam information of time point F2 and indicating the four nzp-CSI-RSs configured for predicted beam information of time point F2. The electronic device 600 may receive and measure downlink monitoring beams carried by the four nzp-CSI-RSs that are transmitted upon activated by the MAC CE activation message based on indications of the configuration information of the 12 nzp-CSI-RSs received earlier and the MAC CE activation message by the communication unit 620 and the measurement unit 640 respectively, thereby obtaining measurement results for the predicted beam information of time point F2. Thereafter, the electronic device 600 on the terminal side may perform similar processing for predicted beam information of time points F4 and F6 and similar interaction with the network side device so as to receive and measure corresponding downlink monitoring beams.

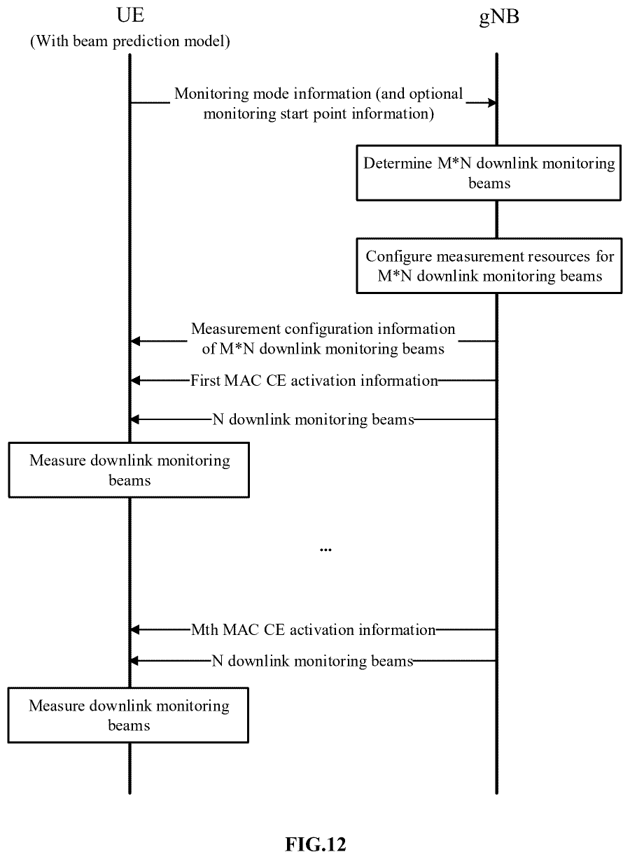

FIG. 12 illustrates a signaling-interaction flow of a second example in which the electronic device 600 measures a downlink monitoring beam. A difference between the example of FIG. 12 and the example of FIG. 11 is that, in FIG. 12, a UE having the functions of the electronic device 600 receives, from a base station gNB serving the UE as the network side device, measurement configuration information of the M*N nzp-CSI-RSs described above (rather than measurement configuration information of one nzp-CSI-RS resource set) as measurement configuration information of M*N downlink monitoring modes, and each time the UE receives an m-th MAC CE message for activating the N nzp-CSI-RSs corresponding to a current m-th monitoring object from the gNB, the UE receives and measures N downlink monitoring beams carried by the N nzp-CSI-RSs based on indications of the measurement configuration information and the MAC CE message until measurement related to all M monitoring objects indicated by all M MAC CE messages is completed (m=1, . . . , M).

### 2.3 Configuration Examples of an Electronic Device Implemented on a Network Side

Next, a case in which an electronic device is implemented on a network side, for example but not limited to being implemented as a base station, is discussed.

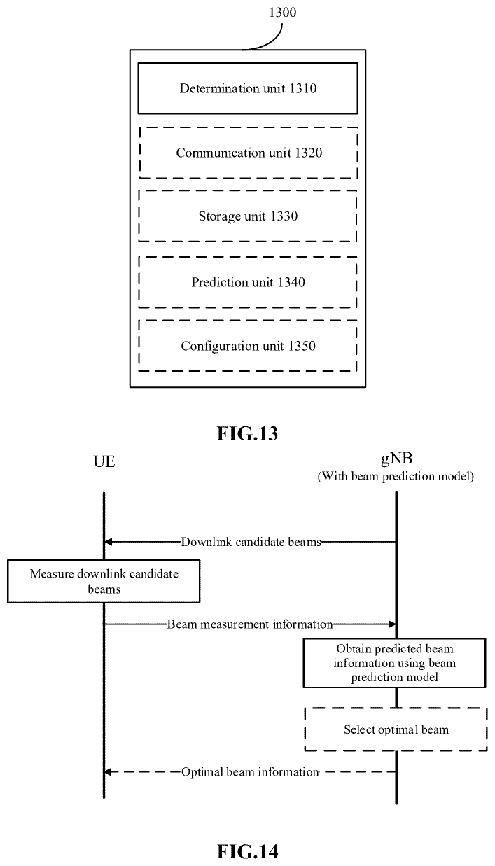

FIG. 13 is a block diagram illustrating a configuration example of an electronic device implemented on a network side. As illustrated in FIG. 13, an electronic device 1300 of the present configuration example may include a determination unit 1310, a communication unit 1320 and a storage unit 1330, which respectively correspond to the determination unit 210, the communication unit 220 and the storage unit 230 of the electronic device illustrated in FIG. 2. A difference between the electronic device 1300 and the electronic device 200 is that the determination unit 1310, the communication unit 1320 and the storage unit 1330 may perform additional operations compared to the respective units of the electronic device 200, and the electronic device 1300 further includes, optionally, an prediction unit 1340 for beam prediction and a configuration unit 1350 for configuring measurement resources of downlink monitoring beams. The following description focuses on these different portions and related processing.

In a case in which the electronic device is implemented on the network side, a beam prediction model may be deployed on the network side or may be deployed on the terminal side. This deployment difference may influence ways in which the electronic device 1300 on the network side acquires information related to the beam prediction model, predicted beam information and the like, but it hardly influences subsequent monitoring of the beam prediction model, because, in the present configuration example, even in a case in which the beam prediction model is deployed on the terminal side, its monitoring is performed by the electronic device 1300 on the network side. Configurations, processing and signaling interactions that may differ depending on deployment of the beam prediction model are described first, and then configurations, processing and signaling interactions related to monitoring that are generally applicable and are hardly influenced by deployment of the beam prediction model are described.

### Acquisition of Information Related to a Beam Prediction Model and the Like

In an example, a beam prediction model may be deployed in the electronic device 1300 on the network side. In this case, the storage unit 1330 of the electronic device 1300 may be configured to store, in advance, a trained beam prediction model (that is, the electronic device 1300 itself has various related information of the beam prediction model, including but not limited to various model parameters) and a list of monitoring modes and channel fading rate sections that are associated with each other, such as that illustrated in FIGS. 3A and/or 3B.

Alternatively, a beam prediction model may be deployed on the terminal side. In this case, the electronic device 1300 on the network side may acquire, simultaneously, information related to the beam prediction model included in the capability information of the terminal device as part thereof (which may indicate various information related to the beam prediction model such as model parameters K and F) when receiving the capability information of the terminal device that is reported by the terminal device via the communication unit 1320. An example of a signaling interaction in which the electronic device 1300 acquires capability information reported by the terminal device may be generally similar to the example illustrated in FIG. 7. In this case, the base station gNB in the figure may have the functions of the electronic device 1300 and may serve the terminal device UE, but the capability information acquired from the UE only includes information related to the beam prediction model and does not include information related to the list of the monitoring modes.

The electronic device 1300 that does not have the beam prediction model may, for example, suitably obtain, by its determination unit 1310, the list of the monitoring modes and the channel fading rate sections that are associated with each other, such as that illustrated in FIGS. 3A and/or 3B, in a way described earlier based on the information related to the beam prediction model received from the terminal device, and store the list in the storage unit 1330.

### Obtaining of Predicted Beam Information and the Like

The electronic device 1300 on the network side may obtain predicted beam information output by the beam prediction model in an appropriate way via necessary interaction with the terminal device, and, optionally, the determination unit 1310 of the electronic device 1300 may further be configured to determine an optimal beam based on the obtained predicted beam information.

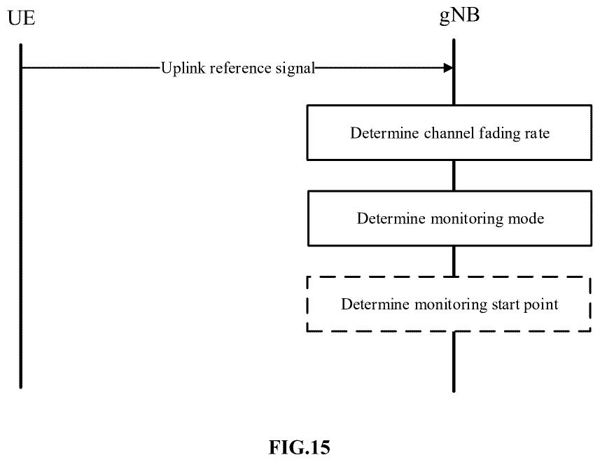

First, a case in which the beam prediction model is deployed on the network side is considered. In this case, the electronic device 1300 on the network side may directly obtain the predicted beam information by using the beam prediction model. FIG. 14 illustrates a flow chart of an example of a signaling interaction in which the electronic device 1300 performs beam prediction (and determines an optimal beam) in this case.

In the example of FIG. 14, a base station gNB having the functions of the electronic device 1300 may transmit, via its communication unit 1320, L downlink candidate beams to a terminal device UE so that the UE measures the downlink candidate beams. The gNB may receive measurement results (measured beam information) of the downlink candidate beams reported by the UE. Thereafter, the gNB may obtain, for example, predicted beam information of F future time points by using, via its prediction unit 1340, the beam prediction model stored in the storage unit 1330 based on measurement results (measured beam information) of the downlink candidate beams of the most recent K measurements or at the most recent K past time points. It should be noted that, although only a single transmission and measurement of the downlink candidate beams and reporting of the measurement results are schematically illustrated in the figure, the process is repeated K times before the gNB performs beam prediction by using the beam prediction model so that the gNB obtains measured beam information of the most recent K measurements or at the most recent K past time points required by the model.

Here, predicted beam information of each future time point obtained by the gNB by using the beam prediction model may, for example, include or indicate predicted information of the first N predicted beams among the L candidate beams. As an example, predicted information of the N predicted beams of a future time point may include identification information of each predicted beam (such as a beam ID) and beam quality expressed, for example, by RSRP (for example L1-RSRP) of each predicted beam (alternatively or additionally, a probability of being the optimal beam (and, optionally, related confidence) and/or other related information that is capable of determining a priority of the predicted beam), and may further include dwell times of the N predicted beams.

The gNB may, for example, select, by its determination unit 1310, one of the N predicted beams of each future time point as an optimal beam based on the obtained predicted beam information of the F future time points, for example but not limited to a predicted beam having the best beam quality (the maximum RSRP). Optionally, the gNB may transmit optimal beam information indicating the selected optimal beam to the UE via its communication unit 1320.

In addition, a case in which the beam prediction model is deployed on the terminal side is considered. In this case, the electronic device 1300 on the network side may receive, from the terminal device, predicted beam information obtained by the terminal device using the beam prediction model. In such a case, an example of a signaling interaction in which the electronic device 1300 on the network side interacts with the terminal device so as to obtain the predicted beam information from the terminal device may be similar to the example illustrated in FIG. 8. In this case, the base station gNB illustrated in FIG. 8 may have the functions of the electronic device 1300 and may serve the terminal device UE.

### Monitoring of the Beam Prediction Model

### Determination of the Monitoring Mode

After the electronic device 1300 on the network side obtains the predicted beam information in an appropriate way and selects the optimal beam of each time point accordingly, during a dwell time of the optimal beam (for example during a dwell time D2 of time point F2 illustrated in FIG. 4A or FIG. 4B), a beam failure of a downlink beam may occur. At this time, monitoring of the beam prediction model will be triggered. In such a case, the electronic device 1300 may determine a monitoring mode corresponding to a current channel characteristic such as a channel fading rate via appropriate interaction with the terminal device, for example. This interaction may be, for example, independent of which side the beam prediction model is deployed on.

FIG. 15 illustrates a flow chart of an example of a signaling interaction in which the electronic device 1300 determines a monitoring mode.

In the example of FIG. 15, a base station gNB having the functions of the electronic device 1300 may receive a predetermined uplink reference signal (for example but not limited to a Sounding Reference Signal (SRS)) transmitted by a terminal device UE via its communication unit 1320, and may determine a current channel fading rate based on the received uplink reference signal by its determination unit 1310 in the way described earlier. Next, the base station gNB may determine a monitoring mode corresponding to an section into which the current channel fading rate falls by its determination unit 1310 referring to the list of the monitoring modes and the channel fading rate sections that are associated with each other (for example having the form illustrated in FIG. 3A or FIG. 3B) stored in the storage unit 1330.

Optionally, the base station gNB may further determine predicted beam information that is taken as a monitoring start point appropriately by the determination unit 1310, for example in the way described above with reference to FIGS. 4A and 4B, which will not be described in detail here.

### Transmission of Downlink Monitoring Beam and the Configuration of Resources

Optionally, the determination unit 1310 of the electronic device 1300 on the network side may further be configured to determine corresponding downlink monitoring beams, that is, predicted beams indicated by predicted beam information that is taken as a monitoring object, based on the obtained predicted beam information and the determined monitoring mode (and, optionally, the determined monitoring start point). The communication unit 1320 may further be configured to transmit the downlink monitoring beams to the terminal device. In addition, the communication unit 1320 may further be configured to receive measurement results of the downlink monitoring beams from the terminal device.

For example, the determination unit 1310 may determine, for example, respective monitoring objects (that is, future time points corresponding to predicted beam information that is taken as the monitoring object) starting from a monitoring start point, based on the determined monitoring mode and, optionally, the determined monitoring start point. The specific process may be similar to the example processing described earlier with reference to FIGS. 5A to 5C and is not repeated here. The determination unit 1310 may determine N predicted beams specified by each piece of predicted beam information that is taken as the monitoring object as downlink monitoring beams of the respective time points, and the communication unit 1320 may transmit corresponding downlink monitoring beams during the beam dwell time of the predicted beam information so that the terminal device may perform corresponding measurement and report the measurement results.

Measurement results of the above downlink monitoring beams are the measurement results of the “predicted beams indicated by predicted beam information that is taken as the monitoring object” described earlier in section “2.1 Configuration example”, and the determination unit 1310 of the electronic device 1300 may determine the performance of the beam prediction model based on the above measurement results in the way described earlier, which will not be described here.

Preferably, in order for the terminal device to measure the downlink monitoring beams, the configuration unit 1350 of the electronic device 1300 may be configured to configure measurement resources of the downlink monitoring beams for the terminal device based on the obtained predicted beam information and the determined monitoring mode, and the configuration unit 1350 may further be configured to generate measurement configuration information indicating the measurement resources of the downlink monitoring beams. Here, the configuration unit 1350 may configure frequency resources of the downlink monitoring beams in various ways, but time resources configured for the downlink monitoring beams should be within the beam dwell time of corresponding predicted beam information that is taken as the monitoring object. The communication unit 1320 of the electronic device 1300 may further be configured to transmit the measurement configuration information indicating the measurement resources of the downlink monitoring beams to the terminal device so that the terminal device may measure the downlink monitoring beams with respect to resources indicated by the measurement configuration information.

Next, two examples in which the electronic device 1300 transmits downlink monitoring beams for the terminal device to measure will be described in conjunction with different configurations of the measurement resources of the downlink monitoring beams. Note that processing and interactions involved in the examples may be, for example, independent of which side the beam prediction model is deployed on.

First, a first example is discussed. In the first example, after determining downlink monitoring beams of a terminal device based on the obtained predicted beam information and the determined monitoring mode, the electronic device 1300 may configure, via RRC signaling, a non-periodic downlink reference-signal resource set for the terminal device to carry the downlink monitoring beams, and may simultaneously trigger respective downlink reference signals in the resource set to be sequentially transmitted based on respective designated slot offsets via a DCI command.

For example, the configuration unit 1350 may configure an nzp-CSI-RS resource set for the terminal device. The resource set may include M subsets that respectively correspond to M monitoring objects, in which an m-th subset includes N nzp-CSI-RSs, a transmitting beam of each nzp-CSI-RS corresponds to one of N predicted beams indicated by predicted beam information that is taken as an m-th monitoring object, that is, one of N downlink monitoring beams that should be transmitted during the beam dwell time corresponding to the m-th monitoring object, where m=1, . . . , M. Alternatively or similarly, each subset may also include N SSBs, which will not be described in detail here.

In such a case, the configuration information of the nzp-CSI-RS resource set (that is, the measurement configuration information of the downlink monitoring beams) that may be generated by the electronic device 1300 using the configuration unit 1350 and transmitted by the communication unit 1320 through RRC signaling to the terminal device may be in the form of a CSI-MeasConfig IE (or, alternatively, in the form of a CSI-ReportConfig IE), in which a measurement item is RSRP (L1-RSRP) and a measurement object (that is, the downlink resource) is the nzp-CSI-RS resource set described above.

Preferably, in this configuration, for each subset in the nzp-CSI-RS resource set, the configuration unit 1350 may configure time resources of N nzp-CSI-RSs in the subset based on measurement time required by the terminal device to measure a single beam so that the N nzp-CSI-RSs in the current subset may be sequentially transmitted and an interval between transmitting times of two temporally adjacent nzp-CSI-RSs is equal to or slightly greater than the measurement time required to measure the single beam. The above configuration of the time resources may be achieved, for example but not limited to, by configuring a distance between slot offsets of respective nzp-CSI-RSs in each subset.

In addition, preferably, for an m-th subset of the non-periodic nzp-CSI-RS resource set, the configuration unit 1350 may configure time resources of N nzp-CSI-RSs in the subset based on a validity time or a beam dwell time corresponding to the m-th monitoring object, so that a transmitting time of each nzp-CSI-RS of the subset is within the above validity time or beam dwell time. As an example, the above configuration of the time resources of a first subset may, for example but not limited to, be achieved by configuring a slot offset of a first nzp-CSI-RS to be transmitted to 1 (that is, the nzp-CSI-RS is transmitted immediately after being triggered by the DCI command), and the above configuration of the time resources of a subsequent m-th subset may be achieved by configuring an appropriate distance between a slot offset of a first nzp-CSI-RS to be transmitted and a slot offset of an N-th nzp-CSI-RS to be transmitted in an (m−1)-th subset, which will not be described in detail here.

The M*N nzp-CSI-RSs of the above non-periodic nzp-CSI-RS resource set may be simultaneously triggered by a DCI command that indicates a resource-set ID of the resource set, and may be sequentially transmitted based on the configured slot offsets, in which the DCI command is generated by the configuration unit 1350 and transmitted by the communication unit 1320.

A non-periodic nzp-CSI-RS resource set configured and triggered in the above way may be applied, for example but not limited to, to a consecutive mode such as the first mode described earlier. For example, assuming that the determination unit 1310 of the electronic device 1300 determines, for example, predicted beam information of time points F2 to F4 in the example of the first mode illustrated in FIG. 5A as monitoring objects based on the obtained predicted beam information and the determined monitoring mode, the configuration unit 1350 of the electronic device 1300 may configure a non-periodic nzp-CSI-RS resource set that includes three subsets respectively for the monitoring of predicted beam information of time points F2, F3 or F4. Each subset includes, for example, N=4 nzp-CSI-RSs that respectively correspond to one of four predicted beams indicated by the predicted beam information of time points F2, F3 or F4, and slot offsets of respective nzp-CSI-RSs satisfy the requirements described above.

The electronic device 1300 may transmit the configuration information generated accordingly and a DCI triggering command, and transmit downlink monitoring beams carried by the nzp-CSI-RS resource set via the communication unit 1320 immediately after the configuration of the nzp-CSI-RS resource set described above is completed by the configuration unit 1350. The terminal device may receive and measure the downlink monitoring beams carried by the nzp-CSI-RS resource set based on indications of the received configuration information of the nzp-CSI-RS resource set and the DCI triggering command.

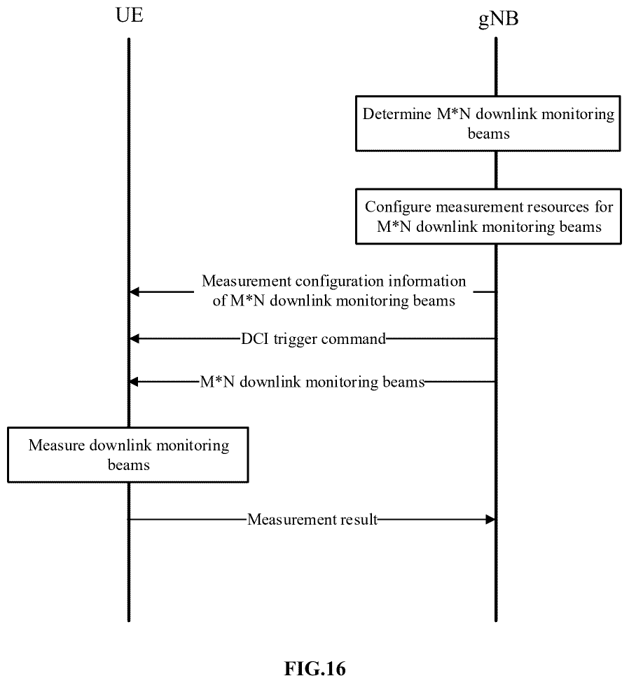

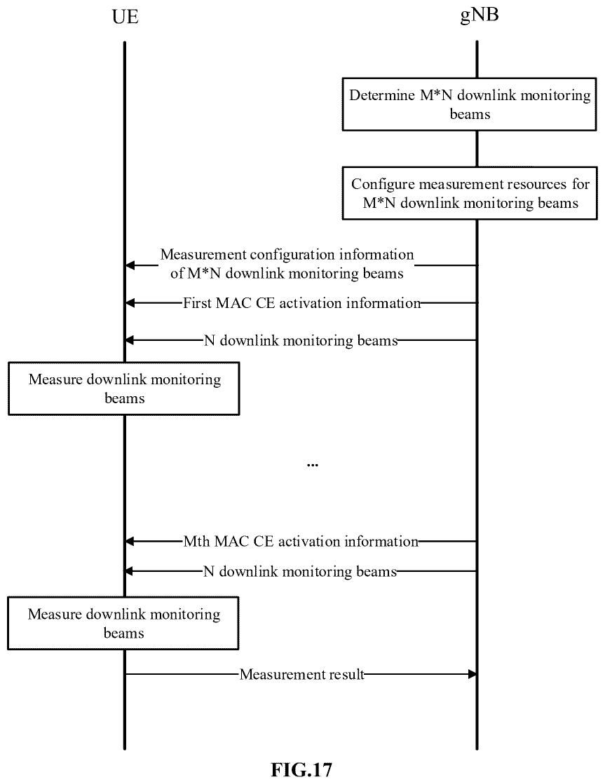

FIG. 16 illustrates a signaling-interaction flow of a first example in which the electronic device 1300 configures and transmits a downlink monitoring beam.

As illustrated in FIG. 16, a gNB having the functions of the electronic device 1300 may determine, for example, M*N downlink monitoring beams for M monitoring objects based on the obtained predicted beam information and the determined monitoring mode (and, optionally, a monitoring start point) by its determination unit 1310. The gNB may configure, by its configuration unit 1350, a non-periodic nzp-CSI-RS resource set, such as that described above, as measurement resources for these downlink monitoring beams, accordingly generate the configuration information thereof as measurement configuration information of the M*N downlink monitoring beams, and transmit the configuration information to a UE via its communication unit 1320. The gNB may also transmit a DCI triggering command for triggering the above resource set to the UE and subsequently transmit the M*N downlink monitoring beams carried by the non-periodic nzp-CSI-RS resource set via its communication unit 1320. After receiving the above measurement configuration information and the corresponding DCI triggering command from the gNB, the UE may receive and measure the M*N downlink monitoring beams carried by the non-periodic nzp-CSI-RS resource set based on indications of the measurement configuration information and the DCI triggering command. In addition, the gNB may receive measurement results reported by the UE via its communication unit 1320.

Next, a second example in which the electronic device 1300 configures and transmits the downlink monitoring beams is discussed. In the second example, after determining downlink monitoring beams of the terminal device based on the obtained predicted beam information and the determined monitoring mode, the electronic device 1300 may configure, via RRC signaling, a plurality of non-periodic downlink reference-signal resources for the electronic device 1300 on the terminal side to carry these downlink monitoring beams, and may activate, for each monitoring object, corresponding downlink reference signals to be sequentially transmitted, for example, based on respective designated

Specifically, for example, the configuration unit 1350 of the electronic device 1300 may configure M*N non-periodic nzp-CSI-RS resources for a total of M*N predicted beams of the determined M monitoring objects that respectively indicate N predicted beams, in which each nzp-CSI-RS resource may correspond to one of the M*N predicted beams, that is, one of the N downlink monitoring beams that should be transmitted during the beam dwell time corresponding to an m-th monitoring object, where m=1, . . . , M, and each nzp-CSI-RS resource may, for example, be represented by a corresponding index among indexes from 1 to M*N. Alternatively or similarly, the network side device may also configure M*N SSBs, which will not be described here.

In such a case, the configuration information of the nzp-CSI-RS resources (that is, the measurement configuration information of the downlink monitoring beams) generated by the electronic device 1300 using the configuration unit 1350 and transmitted by the communication unit 1320 through RRC signaling to the terminal side electronic device 1300 may be in the form of a CSI-MeasConfig IE (or, alternatively, in the form of a CSI-ReportConfig IE), in which a measurement item is RSRP (L1-RSRP) and a measurement object (that is, the downlink resource) is the above M*N nzp-CSI-RSs.

Preferably, in this configuration, the configuration unit 1350 may configure time resources of N nzp-CSI-RSs for each monitoring object so that the N nzp-CSI-RSs may be sequentially transmitted and an interval between transmitting times of two temporally adjacent nzp-CSI-RSs is equal to or slightly greater than the measurement time required to measure a single beam. The above configuration of the time resources may be achieved, for example but not limited to, by configuring a distance between slot offsets of N nzp-CSI-RSs of each monitoring object.

The above M*N non-periodic nzp-CSI-RSs may be correspondingly activated by M MAC CEs generated by the configuration unit 1350 for the M monitoring objects and transmitted by the communication unit 1320 and respectively indicate N nzp-CSI-RSs of a current monitoring object (that is, N nzp-CSI-RSs of a current monitoring object are activated each time), and may be sequentially transmitted based on the configured slot offsets after activation. Here, preferably, a corresponding MAC CE activation message generated by the configuration unit 1350 may be transmitted by the communication unit 1320 as early as possible within the beam dwell time corresponding to each monitoring object so as to ensure that the measurement of corresponding N downlink monitoring beams is completed as early as possible within the time. An example of the MAC CE activation message generated by the configuration unit 1350 in the present example may have a form similar to that illustrated in FIG. 11, which will not be described here.

A non-periodic nzp-CSI-RS resource configured and activated in the way as described above may be applied, for example but not limited to, to a discrete mode such as the second or the third mode described earlier. For example, assuming that the determination unit 1310 of the electronic device 1300 determines, for example, predicted beam information of time points F2, F4 and F6 in the example of the second mode illustrated in FIG. 5B as monitoring objects based on the obtained predicted beam information and the determined monitoring mode, the configuration unit 1350 may configure M*N=3×4=12 non-periodic nzp-CSI-RSs that respectively correspond to one of four predicted beams indicated by predicted beam information of time points F2, F4 or F6, and slot offsets of the respective nzp-CSI-RSs satisfy the requirements described above.

The electronic device 1300 may transmit the configuration information generated by the configuration unit 1350 to the terminal device via the communication unit 1320 immediately after the configuration of the above M*N=12 nzp-CSI-RSs is completed by the configuration unit 1350. Next, within the beam dwell time D2 of predicted beam information of time point F2, the electronic device 1300 may transmit, via the communication unit 1320 as early as possible, a MAC CE activation message generated by the configuration unit 1350 and indicating the four nzp-CSI-RSs configured for predicted beam information of time point F2 so as to activate the four nzp-CSI-RSs, and transmit downlink monitoring beams carried thereby. Based on indications of the configuration information of the 12 nzp-CSI-RSs received earlier and the MAC CE activation message received at this moment, the terminal device may correspondingly receive and measure the downlink monitoring beams carried by the four nzp-CSI-RSs as measurement results for predicted beam information of time point F2. Thereafter, the electronic device 1300 may perform similar processing for predicted beam information of time points F4 and F6 and similar interaction with the terminal device so as to transmit and measure corresponding downlink monitoring beams.

FIG. 17 illustrates a signaling-interaction flow of a second example in which the electronic device 1300 configures and transmits a downlink monitoring beam.

A difference between the example of FIG. 17 and the example of FIG. 16 is that, in FIG. 17, a gNB having the functions of the electronic device 1300 configures, via its configuration unit 1350, M*N nzp-CSI-RSs such as those described above as measurement resources of M*N downlink monitoring beams and generates corresponding configuration information as measurement configuration information of the M*N downlink monitoring beams. Thereafter, within the beam dwell time corresponding to a current m-th monitoring object, the gNB transmits, via its communication unit 1320 (for example as early as possible), a corresponding m-th MAC CE message generated by the configuration unit 1350 so as to activate N nzp-CSI-RSs that correspond to the current monitoring object, and transmits N downlink monitoring beams carried by the N nzp-CSI-RSs so that a terminal device, after receiving the MAC CE message, receives and measures the N downlink monitoring beams carried by the N nzp-CSI-RSs indicated by the MAC CE message based on the measurement configuration information until measurement related to all M monitoring objects indicated by all M MAC CE messages is completed (m=1, . . . , M).

The gNB may receive measurement results of respective downlink monitoring beams reported by the UE via its communication unit 1320. Note that, although FIG. 17 illustrates that the UE reports the measurement results once after completion of measurement of all downlink monitoring beams, the present example is not limited thereto. The UE may, for example but not limited to, report measurement results each time it completes measurement of the N downlink monitoring beams of the current monitoring object, which will not be described here.

Configuration examples of the electronic devices according to the embodiments of the present disclosure and example processing performed thereby have been described above, and example configurations and example processing of the electronic device 600 on the terminal side and the electronic device 1300 on the network side have been respectively described. Based on the above description, part of the processing in the example processing of the electronic device 600 and the electronic device 1300 may, where appropriate, be combined with or replaced by each other, and such combinations and/or replacements are also within the scope of the present disclosure.

In addition, in the description of the electronic devices of the embodiments of the present disclosure above, interaction between the terminal side electronic device 600 and a network side device and interaction between the electronic device 1300 on the network side and a terminal device have also been described, in addition to processing that is performed respectively by the terminal side electronic device 600 and the electronic device 1300 on the network side. In other words, the present disclosure not only provides an electronic device capable of monitoring a beam prediction model, but also correspondingly discloses another device that interacts with the electronic device, the another device is also included in the present disclosure, which will not be described here.

### 3. Method Embodiments

Corresponding to the apparatus embodiments described above, the present disclosure provides the following method embodiments.

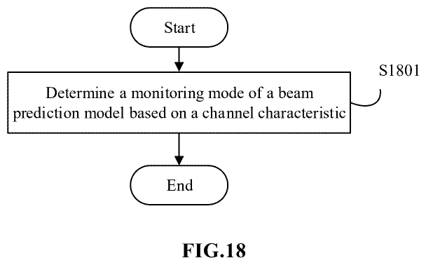

FIG. 18 is a flow chart illustrating an example process of a method for wireless communication according to an embodiment of the present disclosure.

As illustrated in FIG. 18, in step S1801, a monitoring mode of a beam prediction model that obtains predicted beam information of a future time point based on measured beam information may be determined based on a channel characteristic, the monitoring mode indicating a future time point corresponding to predicted beam information that is taken as a monitoring object.

As an example, the channel characteristic may include a channel fading rate.

Optionally, although not illustrated in the figure, a method according to an embodiment may further include determining a current channel fading rate based on a received predetermined reference signal. Correspondingly, in step S1801, based on a section among a plurality of predetermined sections into which a current channel fading rate falls, a mode that corresponds to that section among a plurality of monitoring modes may be determined.

As an example, a plurality of predetermined sections for the channel fading rate and a plurality of monitoring modes may be preset. Among the plurality of predetermined sections, a channel fading rate of a first section may be higher than that of a second section. Among the plurality of monitoring modes, a correlation between a plurality of future time points of a plurality of pieces of predicted beam information indicated by a first mode corresponding to the first section may be higher than a correlation between a plurality of future time points of a plurality of pieces of predicted beam information indicated by a second mode corresponding to the second section.

As an example, the monitoring modes may include a first type of monitoring mode that indicates consecutive future time points and a second type of monitoring mode that indicates discrete future time points.

Optionally, the second type of monitoring mode may include a first mode that indicates future time points corresponding to predicted beam information that are obtained by the beam prediction model based on measured beam information of the same past time points, and a second mode that indicates future time points corresponding to predicted beam information that are obtained by the beam prediction model based on measured beam information of different past time points.

Optionally, although not illustrated in the figure, a method according to an embodiment may further include determining predicted beam information that is taken as a monitoring start point. For example, predicted beam information corresponding to a time point at which a predetermined time elapses since a monitoring trigger time point of the beam prediction model may be determined as the predicted beam information that is taken as the monitoring start point. As an example, the predetermined time may be determined based on the time required to measure all predicted beams indicated by predicted beam information of a future time point.

Optionally, although not illustrated in the figure, a method according to an embodiment may further include determining the performance of the beam prediction model based on a measurement result of a predicted beam indicated by the predicted beam information that is taken as the monitoring object.

In an implementation, a method according to an embodiment may be implemented on a terminal side and may be executed, for example, by a terminal device. In this case, the beam prediction model may be deployed, for example, in the terminal device.

Optionally, although not illustrated in the figure, a method according to an embodiment may further include obtaining predicted beam information by using the beam prediction model and transmitting the obtained predicted beam information to a network side device.

Optionally, although not illustrated in the figure, a method according to an embodiment may further include: transmitting monitoring mode information that indicates the determined monitoring mode to the network side device, and measuring a downlink monitoring beam that is transmitted by the network side device based on the predicted beam information and the monitoring-mode information.

Optionally, although not illustrated in the figure, a method according to an embodiment may further include: receiving measurement configuration information of the downlink monitoring beam that is generated by the network side device based on the predicted beam information and the monitoring-mode information. Correspondingly, the downlink monitoring beam may be measured with respect to resources indicated by the measurement configuration information.

Optionally, although not illustrated in the figure, a method according to an embodiment may further include: reporting a measurement result of the downlink monitoring beam to the network side device. In this case, final determination of the performance of the model may be performed by the network side device.

In another implementation, a method according to this embodiment may be implemented on a network side and may be executed, for example, by a network side device. In that case, a beam prediction model may be deployed on the network side or may be deployed on the terminal side, and no particular limitation is imposed here, rather, appropriate processing may be performed accordingly.

Optionally, although not illustrated in the figure, a method according to an embodiment may further include: obtaining predicted beam information output by the beam prediction model. Here, depending on the deployment of the beam prediction model, the predicted beam information may be obtained directly by using the beam prediction model or the predicted beam information that is obtained by a terminal device by using the beam prediction model may be received.

Optionally, although not illustrated in the figure, a method according to an embodiment may further include: transmitting, to a terminal device, downlink monitoring beams based on the obtained predicted beam information and the determined monitoring mode, and receiving a measurement result of the downlink monitoring beam from the terminal device.

Optionally, although not illustrated in the figure, a method according to an embodiment may further include: configuring, based on the obtained predicted beam information and the determined monitoring mode, measurement resources of the downlink monitoring beam for the terminal device. Correspondingly, the network side device may transmit the downlink monitoring beam to the terminal device by using the configured resources. Optionally, a method according to an embodiment may further include: generating and transmitting, to the terminal device, measurement configuration information that indicates the measurement resources of the downlink monitoring beam.

According to the embodiments of the present disclosure, the subject performing the above method may be the electronic device 200, 600 or 1300 according to the embodiments of the present disclosure. Therefore, all embodiments described earlier with respect to the electronic device 200, 600 or 1300 are applicable hereto.

### 4. Application Examples

The technology according to the present disclosure may be applied to various products.

For example, when the electronic device is implemented on the base station side, the electronic device may be implemented as any type of base station device, such as a macro eNB or a small eNB, and may also be implemented as any type of gNB (a base station in a 5G system). A small eNB may be an eNB covering a cell smaller than a macro cell, such as a pico eNB, a micro eNB, or a home (femto) eNB. Alternatively, the base station may be implemented as any other type of base station, such as a NodeB or a base transceiver station (BTS). The base station may include: a body, also referred to as a base station device, configured to control wireless communications; and one or more remote radio heads (RRHs) arranged at locations different from that of the body.

In addition, a base station side electronic device may further be implemented as any type of TRP. The TRPs may have transmitting and receiving functions, such as receiving information from a user equipment and a base station device and transmitting information to the user equipment and a base station device. In a typical example, the TRPs may provide services to a user equipment and is controlled by a base station device. Furthermore, the TRPs may have a structure similar to the structure of the base station device, or may only have a structure in the base station device related to sending and receiving information.

When the electronic device is implemented on a terminal device side, the electronic device may be various user equipment, which may be implemented as a terminal device (such as a smart phone, a tablet personal computer (PC), a notebook PC, a portable game terminal, a portable/dongle type mobile router, and a digital camera device) or a vehicle terminal (an vehicle navigation device). The user equipment may also be implemented as a terminal (also referred to as a machine type communication (MTC) terminal) that performs machine-to-machine (M2M) communication. In addition, the user equipment may be a wireless communication module (such as an integrated circuit module including a single chip) installed on each of the above-mentioned user equipments.

### Application Examples of a Base Station

### First Application Example

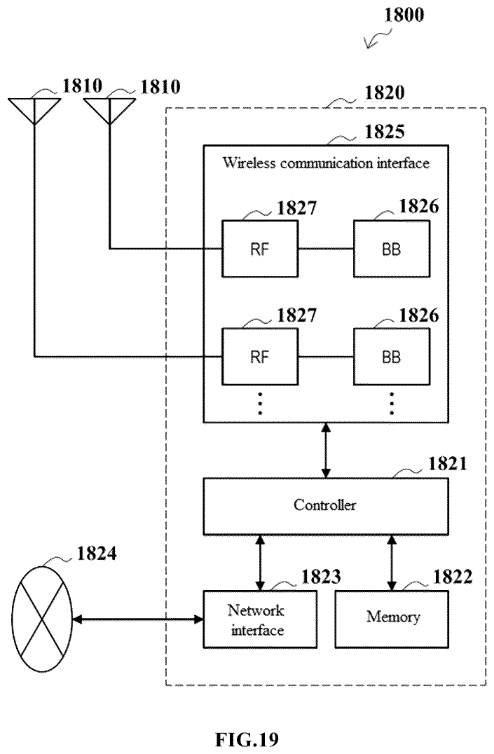

FIG. 19 is a block diagram illustrating a first example of a schematic configuration of an eNB to which the technology of the present disclosure may be applied. An eNB 1800 includes one or more antennas 1810 and a base station device 1820. The base station device 1820 and each of the antennas 1810 may be connected to each other via an RF cable.

Each of the antennas 1810 includes a single or multiple antenna elements (such as multiple antenna elements included in a multiple-input multiple-output (MIMO) antenna), and is used for the base station device 1820 to transmit and receive wireless signals. As illustrated in FIG. 19, the eNB 1800 may include multiple antennas 1810. For example, the multiple antennas 1810 may be compatible with multiple frequency bands used by the eNB 1800. Although FIG. 19 illustrates an example in which the eNB 1800 includes multiple antennas 1810, the eNB 1800 may also include a single antenna 1810.

The base station device 1820 includes a controller 1821, a memory 1822, a network interface 1823, and a wireless communication interface 1825.

The controller 1821 may be, for example, a CPU or a DSP, and manipulate various functions of a higher layer of the base station device 1820. For example, the controller 1821 generates a data packet based on data in a signal processed by the wireless communication interface 1825, and transmits the generated packet via the network interface 1823. The controller 1821 may bundle data from multiple baseband processors to generate a bundled packet, and transfer the generated bundled packet. The controller 1821 may have a logical function for performing control such as radio resource control, radio bearer control, mobility management, admission control, and scheduling. This control may be executed in conjunction with nearby eNBs or core network nodes. The memory 1822 includes an RAM and an ROM, and stores programs executed by the controller 1821 and various types of control data (such as a terminal list, transmission power data, and scheduling data).

The network interface 1823 is a communication interface for connecting the base station device 1820 to a core network 1824. The controller 1821 may communicate with a core network node or another eNB via the network interface 1823. In this case, the eNB 1800 and the core network node or other eNBs may be connected to each other through a logical interface (such as an S1 interface and an X2 interface). The network interface 1823 may also be a wired communication interface, or a wireless communication interface for a wireless backhaul line. If the network interface 1823 is a wireless communication interface, the network interface 1823 may use a higher frequency band for wireless communications than the frequency band used by the wireless communication interface 1825.

The wireless communication interface 1825 supports any cellular communication scheme (such as Long Term Evolution (LTE) and LTE-Advanced), and provides wireless connection to a terminal located in a cell of the eNB 1800 via an antenna 1810. The wireless communication interface 1825 may generally include, for example, a baseband (BB) processor 1826 and an RF circuit 1827. The BB processor 1826 may perform, for example, encoding/decoding, modulation/demodulation, and multiplexing/demultiplexing, and perform various types of signal processing of layers (such as L1, medium access control (MAC), radio link control (RLC), and packet data convergence protocol (PDCP)). Instead of the controller 1821, the BB processor 1826 may have a part or all of the above-mentioned logical functions. The BB processor 1826 may be a memory storing a communication control program, or a module including a processor and related circuits configured to execute the program. The function of the BB processor 1826 may be changed by updating the program. The module may be a card or a blade inserted into a slot of the base station device 1820. Alternatively, the module may be a chip mounted on a card or blade. Meanwhile, the RF circuit 1827 may include, for example, a mixer, a filter, and an amplifier, and transmit and receive a wireless signal via the antenna 1810.

As illustrated in FIG. 19, the wireless communication interface 1825 may include multiple BB processors 1826. For example, the multiple BB processors 1826 may be compatible with multiple frequency bands used by the eNB 1800. As illustrated in FIG. 19, the wireless communication interface 1825 may include multiple RF circuits 1827. For example, the multiple RF circuits 1827 may be compatible with multiple antenna elements. Although FIG. 19 illustrates an example in which the wireless communication interface 1825 includes multiple BB processors 1826 and multiple RF circuits 1827, the wireless communication interface 1825 may also include a single BB processor 1826 or a single RF circuit 1827.

In the eNB 1800 illustrated in FIG. 19, the communication unit of the electronic device 200 or 1300 described with reference to FIGS. 2 and 13 may be implemented by the wireless communication interface 1825 and, optionally, the antenna 1810. At least part of the functions of the prediction unit and configuration unit in the electronic device 1300 and the functions of the determination unit in the electronic device 200 or 1300 may be implemented by the controller 1821. For example, the controller 1821 may, by executing instructions stored in the memory 1822, implement at least part of the functions of the determination unit, prediction unit, and/or configuration unit. Functions of the storage unit in the electronic device 200 or 1300 may be implemented by the memory 1822.

### Second Application Example

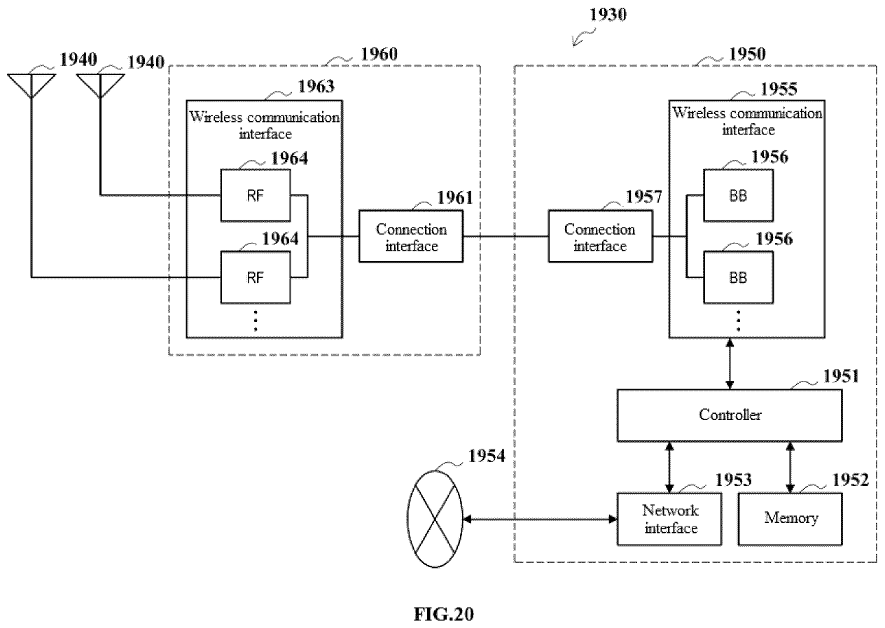

FIG. 20 is a block diagram illustrating a second example of a schematic configuration of an eNB to which the technology of the present disclosure may be applied. An eNB 1930 includes one or more antennas 1940, a base station device 1950, and an RRH 1960. The RRH 1960 and each of the antennas 1940 may be connected to each other via an RF cable. The base station device 1950 and the RRH 1960 may be connected to each other via a high-speed line such as an optical fiber cable.

Each of the antennas 1940 includes a single or multiple antenna elements (such as multiple antenna elements included in a MIMO antenna), and is used for the RRH 1960 to transmit and receive a wireless signal. As illustrated in FIG. 20, the eNB 1930 may include multiple antennas 1940. For example, the multiple antennas 1940 may be compatible with multiple frequency bands used by the eNB 1930. Although FIG. 20 illustrates an example in which the eNB 1930 includes multiple antennas 1940, the eNB 1930 may also include a single antenna 1940.

The base station device 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 described with reference to FIG. 19.

The wireless communication interface 1955 supports any cellular communication scheme (such as LTE and LTE-Advanced), and provides wireless communications to a terminal located in a sector corresponding to the RRH 1960 via the RRH 1960 and the antenna 1940. The wireless communication interface 1955 may generally include, for example, a BB processor 1956. The BB processor 1956 is the same as the BB processor 1826 described with reference to FIG. 19 except that the BB processor 1956 is connected to the RF circuit 1964 of the RRH 1960 via the connection interface 1957. As illustrated in FIG. 20, the wireless communication interface 1955 may include multiple BB processors 1956. For example, the multiple BB processors 1956 may be compatible with multiple frequency bands used by the eNB 1930. Although FIG. 20 illustrates an example in which the wireless communication interface 1955 includes multiple BB processors 1956, the wireless communication interface 1955 may also include a single BB processor 1956.

The connection interface 1957 is an interface for connecting the base station device 1950 (the wireless communication interface 1955) to the RRH 1960. The connection interface 1957 may also be a communication module for communication in the above-mentioned high-speed line that connects the base station device 1950 (the wireless communication interface 1955) to the RRH 1960.

The RRH 1960 includes a connection interface 1961 and a wireless communication interface 1963.

The connection interface 1961 is an interface for connecting the RRH 1960 (the wireless communication interface 1963) to the base station device 1950. The connection interface 1961 may also be a communication module for communication in the above-mentioned high-speed line.

The wireless communication interface 1963 transmits and receives wireless signals via the antenna 1940. The wireless communication interface 1963 may generally include, for example, an RF circuit 1964. The RF circuit 1964 may include, for example, a mixer, a filter, and an amplifier, and transmit and receive wireless signals via the antenna 1940. As illustrated in FIG. 20, the wireless communication interface 1963 may include multiple RF circuits 1964. For example, the multiple RF circuits 1964 may support multiple antenna elements. Although FIG. 20 illustrates an example in which the wireless communication interface 1963 includes multiple RF circuits 1964, the wireless communication interface 1963 may also include a single RF circuit 1964.

In the eNB 1930 illustrated in FIG. 20, the communication unit in the electronic device 200 or 1300 described with reference to FIG. 2 or FIG. 13 may be implemented, for example, by the wireless communication interface 1963 and, optionally, the antenna 1940. At least part of the functions of the prediction unit and the configuration unit in the electronic device 1300 and the functions of the determination unit in the electronic device 200 or 1300 may be implemented by the controller 1951. For example, the controller 1951 may implement at least part of the functions of the determination unit, the prediction unit and/or the configuration unit by executing instructions stored in the memory 1952. Functions of the storage unit in the electronic device 200 or 1300 may be implemented by the memory 1952.

### Application Examples of a User Equipment

### First Application Example

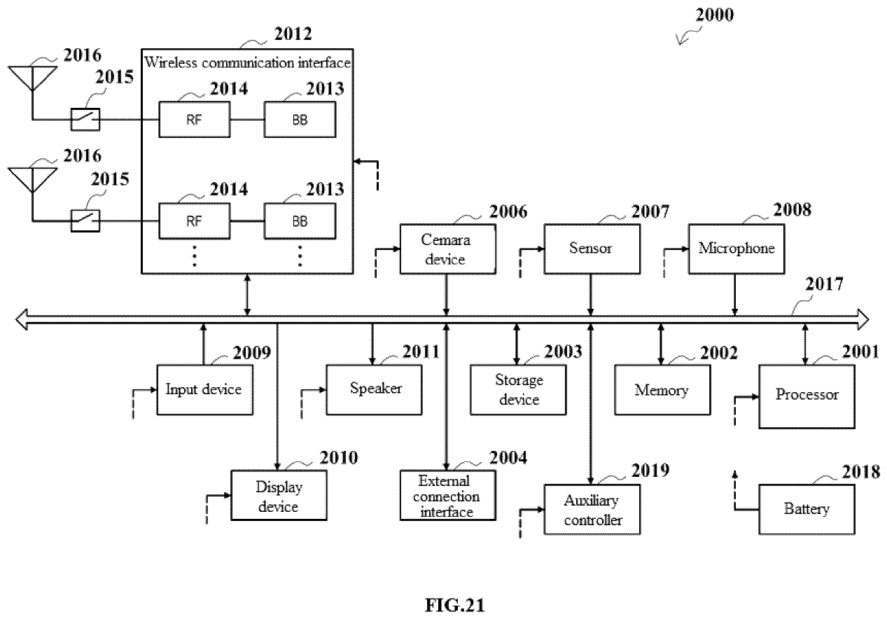

FIG. 21 is a block diagram illustrating an example of a schematic configuration of a smart phone 2000 to which the technology of the present disclosure may be applied. The smart phone 2000 includes a processor 2001, a memory 2002, a storage device 2003, an external connection interface 2004, a camera device 2006, a sensor 2007, a microphone 2008, an input device 2009, a display device 2010, a speaker 2011, a wireless communication interface 2012, one or more antenna switches 2015, one or more antennas 2016, a bus 2017, a battery 2018, and an auxiliary controller 2019.

The processor 2001 may be, for example, a CPU or a system on a chip (SoC), and controls the functions of the application layer and other layers of the smart phone 2000. The memory 2002 includes an RAM and an ROM, and stores data and programs executed by the processor 2001. The storage device 2003 may include a storage medium such as a semiconductor memory and a hard disk. The external connection interface 2004 is an interface for connecting an external device (such as a memory card and a universal serial bus (USB) device) to the smart phone 2000.

The camera device 2006 includes an image sensor (such as a charge coupled device (CCD) and a complementary metal oxide semiconductor (CMOS)), and generates a captured image. The sensor 2007 may include a group of sensors, such as a measurement sensor, a gyroscope sensor, a geomagnetic sensor, and an acceleration sensor. The microphone 2008 converts sound inputted to the smart phone 2000 into an audio signal. The input device 2009 includes, for example, a touch sensor, a keypad, a keyboard, a button, or a switch configured to detect a touch on a screen of the display device 2010, and receives an operation or information input from a user. The display device 2010 includes a screen (such as a liquid crystal display (LCD) and an organic light emitting diode (OLED) display), and displays an output image of the smart phone 2000. The speaker 2011 converts an audio signal outputted from the smart phone 2000 into sound.

The wireless communication interface 2012 supports any cellular communication scheme (such as LTE and LTE-Advanced), and performs wireless communication. The wireless communication interface 2012 may generally include, for example, a BB processor 2013 and an RF circuit 2014. The BB processor 2013 may perform, for example, encoding/decoding, modulation/demodulation, and multiplexing/demultiplexing, and perform various types of signal processing for wireless communications. Further, the RF circuit 2014 may include, for example, a mixer, a filter, and an amplifier, and transmit and receive wireless signals via the antenna 2016. The wireless communication interface 2012 may be a chip module on which the BB processor 2013 and the RF circuit 2014 are integrated. As illustrated in FIG. 21, the wireless communication interface 2012 may include multiple BB processors 2013 and multiple RF circuits 2014. Although FIG. 21 illustrates an example in which the wireless communication interface 2012 includes multiple BB processors 2013 and multiple RF circuits 2014, the wireless communication interface 2012 may also include a single BB processor 2013 or a single RF circuit 2014.

In addition to the cellular communication scheme, the wireless communication interface 2012 may support another type of wireless communication scheme, such as a short-range wireless communication scheme, a near field communication scheme, and a wireless local area network (LAN) scheme. In this case, the wireless communication interface 2012 may include a BB processor 2013 and an RF circuit 2014 for each wireless communication scheme.

Each of the antenna switches 2015 switches a connection destination of the antenna 916 among multiple circuits included in the wireless communication interface 2012 (for example, circuits for different wireless communication schemes).

Each of the antennas 2016 includes a single or multiple antenna elements (such as multiple antenna elements included in a MIMO antenna), and is used for the wireless communication interface 2012 to transmit and receive wireless signals. As illustrated in FIG. 21, the smart phone 2000 may include multiple antennas 2016. Although FIG. 21 illustrates an example in which the smart phone 2000 includes multiple antennas 2016, the smart phone 2000 may also include a single antenna 2016.

In addition, the smart phone 2000 may include an antenna 2016 for each wireless communication scheme. In this case, the antenna switch 2015 may be omitted from the configuration of the smart phone 2000.

The processor 2001, the memory 2002, the storage device 2003, the external connection interface 2004, the camera device 2006, the sensor 2007, the microphone 2008, the input device 2009, the display device 2010, the speaker 2011, the wireless communication interface 2012, and the auxiliary controller 2019 are connected to each other via the bus 2017. The battery 2018 supplies power to each block of the smart phone 2000 illustrated in FIG. 21 via a feeder line, and the feeder line is partially illustrated as a dashed line in the Figure. The auxiliary controller 2019, for example, operates the least necessary function of the smart phone 2000 in the sleep mode.

In the smart phone 2000 illustrated in FIG. 21, the communications unit in the electronic device 200 or 600 described with reference to FIG. 2 or FIG. 6 may be implemented by the wireless communication interface 2012 and, optionally, the antenna 2016. At least part of the functions of the prediction unit and the measurement unit in the electronic device 600 and the functions of the determination unit in the electronic device 200 or 600 may be implemented by the processor 2001 or the auxiliary controller 2019. For example, the processor 2001 or the auxiliary controller 2019 may implement at least part of the functions of the determination unit, prediction unit and/or measurement unit by executing instructions stored in the memory 2002 or in the storage device 2003. Functions of the storage unit in the electronic device 200 or 600 may be implemented by the memory 2002 or the storage device 2003.

### Second Application Example

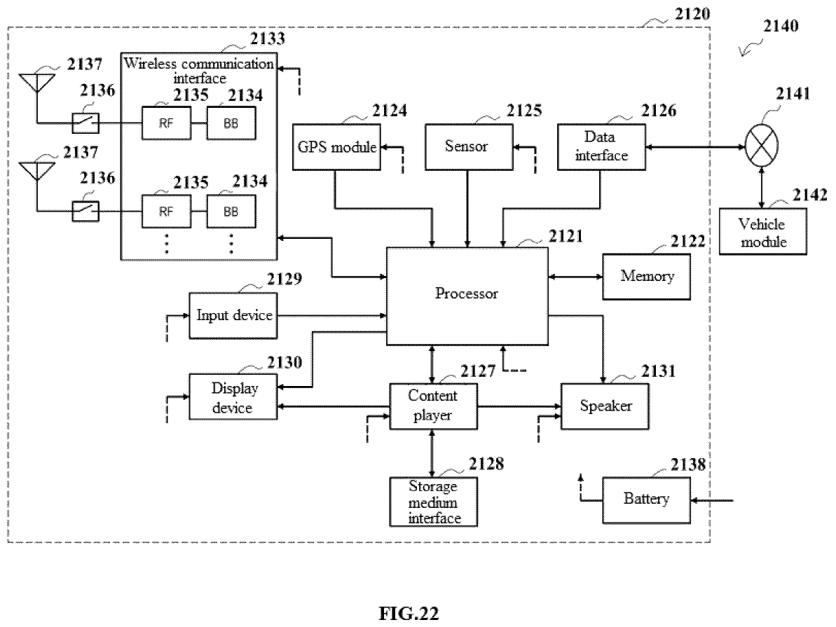

FIG. 22 is a block diagram illustrating an example of a schematic configuration of a vehicle navigation device 2120 to which the technology according to the present disclosure may be applied. The vehicle navigation device 2120 includes a processor 2121, a memory 2122, a global positioning system (GPS) module 2124, a sensor 2125, a data interface 2126, a content player 2127, a storage medium interface 2128, an input device 2129, a display device 2130, a speaker 2131, a wireless communication interface 2133, one or more antenna switches 2136, one or more antennas 2137, and a battery 2138.

The processor 2121 may be, for example, a CPU or a SoC, and controls the navigation function of the vehicle navigation device 2120 and other functions. The memory 2122 includes an RAM and an ROM, and stores data and programs executed by the processor 2121.

The GPS module 2124 measures a position (such as a latitude, a longitude, and a altitude) of the vehicle navigation device 2120 based on a GPS signal received from a GPS satellite. The sensor 2125 may include a group of sensors, such as a gyroscope sensor, a geomagnetic sensor, and an air pressure sensor. The data interface 2126 is connected to, for example, an in-vehicle network 2141 via a terminal not illustrated, and acquires data (such as vehicle speed data) generated by the vehicle.

The content player 2127 reproduces content stored in a storage medium (such as a CD and a DVD), which is inserted into the storage medium interface 2128. The input device 2129 includes, for example, a touch sensor, a button, or a switch configured to detect a touch on a screen of the display device 2130, and receives an operation or information input from the user. The display device 2130 includes a screen such as an LCD or OLED display, and displays an image of a navigation function or reproduced content. The speaker 2131 outputs the sound of the navigation function or the reproduced content.

The wireless communication interface 2133 supports any cellular communication scheme (such as LTE and LTE-Advanced), and performs wireless communication. The wireless communication interface 2133 may generally include, for example, a BB processor 2134 and an RF circuit 2135. The BB processor 2134 may perform, for example, encoding/decoding, modulation/demodulation, and multiplexing/demultiplexing, and perform various types of signal processing for wireless communication. Further, the RF circuit 2135 may include, for example, a mixer, a filter, and an amplifier, and transmit and receive wireless signals via the antenna 2137. The wireless communication interface 2133 may also be a chip module on which the BB processor 2134 and the RF circuit 2135 are integrated. As illustrated in FIG. 22, the wireless communication interface 2133 may include multiple BB processors 2134 and multiple RF circuits 2135. Although FIG. 22 illustrates an example in which the wireless communication interface 2133 includes multiple BB processors 2134 and multiple RF circuits 2135, the wireless communication interface 2133 may also include a single BB processor 2134 or a single RF circuit 2135.

In addition to the cellular communication scheme, the wireless communication interface 2133 may support another type of wireless communication scheme, such as a short-range wireless communication scheme, a near field communication scheme, and a wireless LAN scheme. In this case, the wireless communication interface 2133 may include a BB processor 2134 and an RF circuit 2135 for each wireless communication scheme.

Each of the antenna switches 2136 switches a connection destination of the antenna 2137 among multiple circuits included in the wireless communication interface 2133 (such as, circuits for different wireless communication schemes).

Each of the antennas 2137 includes a single or multiple antenna elements (such as multiple antenna elements included in a MIMO antenna), and is used for the wireless communication interface 2133 to transmit and receive wireless signals. As illustrated in FIG. 22, the vehicle navigation device 2120 may include multiple antennas 2137. Although FIG. 22 illustrates an example in which the vehicle navigation device 2120 includes multiple antennas 2137, the vehicle navigation device 2120 may also include a single antenna 2137.

In addition, the vehicle navigation device 2120 may include an antenna 2137 for each wireless communication scheme. In this case, the antenna switch 2136 may be omitted from the configuration of the vehicle navigation device 2120.

The battery 2138 supplies power to each block of the vehicle navigation device 2120 as illustrated in FIG. 22 via a feeder line, and the feeder line is partially illustrated as a dashed line in the Figure. The battery 2138 accumulates electric power supplied from the vehicle.

In the vehicle navigation device 2120 illustrated in FIG. 22, the communication unit in the electronic device 200 or 600 described with reference to FIG. 2 or FIG. 6 may be implemented by the wireless communication interface 2133 and, optionally, the antenna 2137. At least part of the functions of the prediction unit and the measurement unit in the electronic device 600 and the functions of the determination unit in the electronic device 200 or 600 may be implemented by the processor 2121. For example, the processor 2121 may implement at least part of the functions of the determination unit, the prediction unit and/or the measurement unit by executing instructions stored in the memory 2122. Functions of the storage unit in the electronic device 200 or 600 may be implemented by the memory 2122.

The technology of the present disclosure may also be implemented as an in-vehicle system (or vehicle) 2140 including one or more blocks in the vehicle navigation device 2120, the in-vehicle network 2141, and a vehicle module 2142. The vehicle module 2142 generates vehicle data (such as vehicle speed, engine speed, and failure information), and outputs the generated data to the in-vehicle network 2141.

The preferred embodiments of the present disclosure have been described above with reference to the accompanying drawings. Apparently, the present disclosure is not limited to the above embodiments. Those skilled in the art may obtain various changes and modifications within the scope of the appended claims, and it should be understood that these changes and modifications are fall within the technical scope of the present disclosure.

For example, the units illustrated in dashed boxes in the functional block diagrams illustrated in the drawings indicate that the functional units are optional in the corresponding device, and the various optional functional units may be combined in an appropriate way to perform required functions.

For example, the functions included in one unit in the above embodiments may be realized by separate devices. Alternatively, the functions implemented by multiple units in the above embodiments may be implemented by separate devices, respectively. In addition, one of the above functions may be implemented by multiple units. It should be understood that the above configurations are included in the technical scope of the present disclosure.

In this specification, the steps described in the flowchart may be performed in the chronological order described herein, and may be performed in parallel or independently rather than necessarily in the chronological order. In addition, the chronological order in which the steps are performed may be changed appropriately.

In addition, the present disclosure may have the following configurations.
1. An electronic device, comprising:
processing circuitry, configured to:
determine, based on a channel characteristic, a monitoring mode for a beam prediction model that obtains predicted beam information of a future time point based on measured beam information, the monitoring mode indicating a future time point corresponding to predicted beam information that is taken as a monitoring object.
2. The electronic device according to configuration 1, wherein the channel characteristic comprises a channel fading rate.
3. The electronic device according to configuration 2, wherein the processing circuitry is further configured to determine a current channel fading rate based on a received predetermined reference signal.
4. The electronic device according to configuration 2, wherein the processing circuitry is further configured to determine, based on a section among a plurality of predetermined sections into which a current channel fading rate falls, a mode that corresponds to that section among a plurality of monitoring modes.
5. The electronic device according to configuration 4, wherein
among the plurality of predetermined sections, a channel fading rate of a first section is greater than that of a second section, and
among the plurality of monitoring modes, a correlation between a plurality of future time points of a plurality of pieces of predicted beam information indicated by a first mode corresponding to the first section is higher than a correlation between a plurality of future time points of a plurality of pieces of predicted beam information indicated by a second mode corresponding to the second section.
6. The electronic device of any one of configurations 1 to 5, wherein the monitoring mode comprises:
a first type of monitoring mode that indicates consecutive future time points; and
a second type of monitoring mode that indicates discrete future time points.
7. The electronic device according to configuration 6, wherein the second type of monitoring mode comprises:
a first mode that indicates future time points corresponding to predicted beam information that are obtained by the beam prediction model based on measured beam information of the same past time points; and
a second mode that indicates future time points corresponding to predicted beam information that are obtained by the beam prediction model based on measured beam information of different past time points.
8. The electronic device according to configuration 1, wherein the processing circuitry is further configured to determine predicted beam information that is taken as a monitoring start point.
9. The electronic device according to configuration 7, wherein the processing circuitry is further configured to determine, as the predicted beam information that is taken as the monitoring start point, predicted beam information corresponding to a time point at which a predetermined time elapses since a monitoring trigger time point of the beam prediction model.
10. The electronic device according to configuration 9, wherein the predetermined time is determined based on the time required to measure all predicted beams indicated by predicted beam information of a future time point.
11. The electronic device according to configuration 1, wherein the processing circuitry is further configured to determine the performance of the beam prediction model based on a measurement result of a predicted beam indicated by the predicted beam information that is taken as the monitoring object.
12. The electronic device according to configuration 1, wherein the electronic device is a terminal device, and the processing circuitry is further configured to:
obtain predicted beam information by using the beam prediction model, and
transmit the obtained predicted beam information to a network side device.
13. The electronic device according to configuration 12, wherein the processing circuitry is further configured to:
transmit monitoring mode information that indicates the determined monitoring mode to the network side device; and
measure a downlink monitoring beam that is transmitted by the network side device based on the predicted beam information and the monitoring mode information.
14. The electronic device according to configuration 13, wherein the processing circuitry is further configured to:
receive measurement configuration information of the downlink monitoring beam that is generated by the network side device based on the predicted beam information and the monitoring mode information; and
measure the downlink monitoring beam with respect to resources indicated by the measurement configuration information.
15. The electronic device according to configuration 13 or 14, wherein the processing circuitry is further configured to report a measurement result of the downlink monitoring beam to the network side device.
16. The electronic device according to configuration 1, wherein the electronic device is a network side device, and the processing circuitry is further configured to:
obtain predicted beam information output by the beam prediction model.
17. The electronic device according to configuration 16, wherein the processing circuitry is further configured to:
transmit, to a terminal device, a downlink monitoring beam based on the obtained predicted beam information and the determined monitoring mode; and
receive a measurement result of the downlink monitoring beam from the terminal device.
18. The electronic device according to configuration 17, wherein the processing circuitry is further configured to:
configure, based on the predicted beam information and the determined monitoring mode, measurement resources of the downlink monitoring beam for the terminal device; and
transmit the downlink monitoring beam to the terminal device by using the configured resources.
19. The electronic device according to configuration 18, wherein the processing circuitry is further configured to:
directly obtain predicted beam information by using the beam prediction model or receive predicted beam information that is obtained by the terminal device by using the beam prediction model; and
generate and transmit, to the terminal device, measurement configuration information that indicates the measurement resources of the downlink monitoring beam.
20. a Method for Wireless Communication, Comprising:
determining, based on a channel characteristic, a monitoring mode for a beam prediction model that obtains predicted beam information of a future time point based on measured beam information, the monitoring mode indicating a future time point corresponding to predicted beam information that is taken as a monitoring object.
21. A non-transitory computer-readable storage medium having an executable instruction stored thereon, wherein the executable instruction, when executed by a processor, causes the processor to perform the method for wireless communication according to configuration 20.

Although the embodiments of the present disclosure have been described above in detail in connection with the drawings, it should be appreciated that the embodiments described above are merely illustrative rather than limitative of the present disclosure. Those skilled in the art may make various modifications and variations to the above embodiments without departing from the spirit and scope of the present disclosure. Therefore, the scope of the present disclosure is defined merely by the appended claims and their equivalents.

1. An electronic device, comprising:
processing circuitry, configured to:
determine, based on a channel characteristic, a monitoring mode for a beam prediction model that obtains predicted beam information of a future time point based on measured beam information, the monitoring mode indicating a future time point corresponding to predicted beam information that is taken as a monitoring object.

2. The electronic device according to claim 1, wherein the channel characteristic comprises a channel fading rate.

3. The electronic device according to claim 2, wherein the processing circuitry is further configured to determine a current channel fading rate based on a received predetermined reference signal.

4. The electronic device according to claim 2, wherein the processing circuitry is further configured to determine, based on a section among a plurality of predetermined sections into which a current channel fading rate falls, a mode that corresponds to that section among a plurality of monitoring modes.

5. The electronic device according to claim 4, wherein
among the plurality of predetermined sections, a channel fading rate of a first section is greater than that of a second section, and
among the plurality of monitoring modes, a correlation between a plurality of future time points of a plurality of pieces of predicted beam information indicated by a first mode corresponding to the first section is higher than a correlation among a plurality of future time points of a plurality of pieces of predicted beam information indicated by a second mode corresponding to the second section.

6. The electronic device according to claim 1, wherein the monitoring mode comprises:
a first type of monitoring mode that indicates consecutive future time points; and
a second type of monitoring mode that indicates discrete future time points.

7. The electronic device according to claim 6, wherein the second type of monitoring mode comprises:
a first mode that indicates future time points corresponding to predicted beam information that are obtained by the beam prediction model based on measured beam information of the same past time points; and
a second mode that indicates future time points corresponding to predicted beam information that are obtained by the beam prediction model based on measured beam information of different past time points.

8. The electronic device according to claim 1, wherein the processing circuitry is further configured to determine predicted beam information that is taken as a monitoring start point.

9. The electronic device according to claim 7, wherein the processing circuitry is further configured to determine, as predicted beam information that is taken as a monitoring start point, predicted beam information corresponding to a time point at which a predetermined time elapses since a monitoring trigger time point of the beam prediction model.

10. The electronic device according to claim 9, wherein the predetermined time is determined based on the time required to measure all predicted beams indicated by predicted beam information of a future time point.

11. The electronic device according to claim 1, wherein the processing circuitry is further configured to determine the performance of the beam prediction model based on a measurement result of a predicted beam indicated by the predicted beam information that is taken as the monitoring object.

12. The electronic device according to claim 1, wherein the electronic device is a terminal device, and the processing circuitry is further configured to:
obtain predicted beam information by using the beam prediction model, and
transmit the obtained predicted beam information to a network side device.

13. The electronic device according to claim 12, wherein the processing circuitry is further configured to:
transmit monitoring mode information that indicates the determined monitoring mode to the network side device; and
measure a downlink monitoring beam that is transmitted by the network side device based on the predicted beam information and the monitoring mode information.

14. The electronic device according to claim 13, wherein the processing circuitry is further configured to:
receive measurement configuration information of the downlink monitoring beam that is generated by the network side device based on the predicted beam information and the monitoring mode information; and
measure the downlink monitoring beam with respect to resources indicated by the measurement configuration information.

15. The electronic device according to claim 13, wherein the processing circuitry is further configured to report a measurement result of the downlink monitoring beam to the network side device.

16. The electronic device according to claim 1, wherein the electronic device is a network side device, and the processing circuitry is further configured to:
obtain predicted beam information output by the beam prediction model.

17. The electronic device according to claim 16, wherein the processing circuitry is further configured to:
transmit, to a terminal device, a downlink monitoring beam based on the obtained predicted beam information and the determined monitoring mode; and
receive a measurement result of the downlink monitoring beam from the terminal device.

18. The electronic device according to claim 17, wherein the processing circuitry is further configured to:
configure, based on the predicted beam information and the determined monitoring mode, measurement resources of the downlink monitoring beam for the terminal device; and
transmit the downlink monitoring beam to the terminal device by using the configured resources.

19. (canceled)

20. A method for wireless communication, comprising:
determining, based on a channel characteristic, a monitoring mode for a beam prediction model that obtains predicted beam information of a future time point based on measured beam information, the monitoring mode indicating a future time point corresponding to predicted beam information that is taken as a monitoring object.

21. A non-transitory computer-readable storage medium having an executable instruction stored thereon, wherein the executable instruction, when executed by a processor, causes the processor to perform the method for wireless communication according to claim 20.
